(19) United States
(12) Patent Application Publication
(10) Pub. No.: US 2013/0080203 A1
(43) Pub. Date: Mar. 28, 2013

(54) System and method for time sensitive scheduling data grid flow management

(71) Applicant: Robert Bernard Coley, Palo Alto, CA (US)

(72) Inventor: Robert Bernard Coley, Palo Alto, CA (US)

(21) Appl. No.: 13/672,566

(22) Filed: Nov. 8, 2012

Related U.S. Application Data
(63) Continuation of application No. 12/316,334, filed on Dec. 10, 2008, now abandoned.
(60) Provisional application No. 61/016,022, filed on Dec. 21, 2007.

(51) Int. Cl. G06Q 10/10

(52) U.S. Cl. CPC G06Q 10/1093
USPC 705/7.18

(57) ABSTRACT

Controlling the flow of content and receipt of time sensitive scheduling data via a time sensitive scheduling data delivery network is described. This may involve accommodating the management of the display of potentially voluminous time sensitive scheduling data. This may also involve making all of the relevant time sensitive scheduling data information available from high capacity remote data stores accessible to all of a user's time sensitive scheduling data receiving devices via a time sensitive scheduling data network, and on demand by time sensitive scheduling data display zone category to the user's time sensitive scheduling data receiving devices. The user may dynamically manage which display zone classes and subclasses of time sensitive scheduling data appear, what time frame appears and how much time sensitive scheduling data appears on the user's time sensitive scheduling data receiving device display screens.

### CROSS-REFERENCE TO RELATED APPLICATIONS

This application is a continuation of U.S. patent application Ser. No. 12/316,334, filed Dec. 10, 2008, which claims priority benefit of U.S. Provisional Patent Application No. 61/016,022, entitled, “SYSTEM AND METHOD FOR TIME SENSITIVE SCHEDULING DATA GRID FLOW MANAGEMENT,” by Robert B. Coley, filed Dec. 21, 2007, and each of the above listed applications is incorporated herein by reference in its entirety.

### BACKGROUND OF THE INVENTION

1. Field of the Invention

The invention relates to information dissemination technologies, internet data publication techniques and targeted communications.

2. Description of the Related Art

At present, when an individual wants to refer to or retrieve personally relevant scheduling information, the individual must have 1) manually collected the information from various sources and manually recorded the information on paper, 2) entered the manually collected information in a calendaring/time management software product and recalled the information entered, 3) utilized another individual (a personal assistant) to collect and aggregate the information, then refer to paper or display output, 4) called the source or keeper of the activity data and request the information about the event or meeting, or 5) utilized a company partitioned group calendaring/time management software product which is restricted to company relevant activities and refer to a group enabled calendar.

It is difficult for individuals using such currently available methods to maintain their personal calendars and/or schedules that require the initiation and management of the aggregation of activity data from many sources that impact their daily lives. Often, for the most important activity information, the individual must be present at the meeting (scheduling session), must be a party at the appointment (e.g., medical consultation) or must be represented at the scheduling session (e.g., posting of exam testing schedules). For an individual not directly involved with the source organization, the individual must scan general publication sources manually or electronically to discover events or meeting of interest, then transfer the data to their personal calendaring/scheduling records for later retrieval.

Currently, a user may have to record activity data items on multiple devices in order to keep themselves up to date and to have important scheduling data on hand whenever needed. This process is both time consuming and often presents a challenge since all of the devices may not be present at the time new activity data is discovered or received. Often the user's devices exist in unsynchronized states. For many users, the task of maintaining a consistent list of even the user's most important activity data on all of the user's devices used to track the user's schedule or provide planning data is overwhelming, complex and costly.

Currently, a user may have to manually synchronize his stores of activity data or initiate an automated synchronization process in order to maintain consistent data amongst the user's device or tool data stores. Even when the user has automated tools or applications to synchronize devices capable of maintaining and displaying the user's calendar of activities, the results may be less than desirable. The devices or activity management tools may not communicate with each other and therefore require the user to manually synchronize each entry. The devices or activity management tools may have incompatible operating systems and/or applications software for maintaining activity data and therefore require the user to manually synchronize some or all of the entries. The devices or activity management tools may have inconsistent table schemas for storage of activity data and therefore require the user to lose some of the information available on specific devices. Some of these devices are small and have limited storage capacity, but they are the most convenient to carry around and therefore the most likely to be on hand. The devices or activity management tools may have limited or restricted internal storage capacity for activity data and therefore require the user to eliminate historical information or limit recording current activity data information.

Using currently available methods, when a user has scheduling conflicts revealed by their calendaring applications, the user is generally forced to evaluate which activity data items to display, i.e., maintain in a calendaring application. Instead of entering or storing all of the types of activity data which may be relevant to a time period and of interest to the user, the user must make on the spot decision to drop information to accommodate limited display and/or storage space. One problem in this scenario is that a calendared activity data item such as a meeting, an event or delivery may be rescheduled at a later time thereby eliminating what once was, a competition for display space and a metaphor for a real life conflict. If the user did not store the activity data item which was in conflict with the originally saved item, then that information may no longer be at hand to recall and enter now that the calendar slot is available. To carry this scenario a step further, the user may have had a conflict between numerous activity items of interest such as concerts occurring at the same time. Resolving the conflict at the time may have been a low priority or may have required consulting someone not present at the time. What generally occurs is that the information is not recorded and often forgotten. Later when the importance of making the attendance decision has risen to a priority, the activity's information may have been forgotten or may require considerable effort to find again.

Using currently available methods, a user requiring and maintaining significant volumes of activity data may find it difficult to place all of the information which they would like present for planning purposes within the physical layouts provided by automated calendaring and scheduling applications or they have to give up the benefits of automated systems when manual paper based methods are used. An additional factor in this challenge is that all activity data items are treated alike (given equal weight) for display purposes by many current automated systems. A few applications provide a priority marker option which may allow the application to display one calendared activity data item over another when display space is limited. However, this method does not recognize the fact that priority of an activity data item may change dramatically according to the planning or scheduling decision being considered and the time frame in which it is being considered. As a result many people only maintain the most critical information in their calendaring and scheduling programs and are forced to make on the spot decisions to drop information to conform to limited display space. Information which they may find valuable at a later point must be recorded manually on paper, outside their calendar and scheduling program or not at all. For example, a user at work relying on a Personal Digital Assistant (PDA) to maintain their schedule and who is looking ahead to the next month's schedule of project meetings may have assigned staff meetings a medium priority and project meetings a high priority because of the need to attend all project meetings; it may even be company policy. Now in the event of a schedule conflict and limited display space, a project meeting displays instead of a staff meeting. If an issues arises which requires review at a staff meeting, being able to see all of the staff meetings become a priority.

### SUMMARY OF THE INVENTION

The present disclosure accommodates flow management of time sensitive scheduling data to a time sensitive scheduling data receiving device via a time sensitive scheduling data delivery network. Also the flow management may be related to passive delivery of the time sensitive scheduling data.

In one embodiment of the invention, controlling the flow of content and receipt of time sensitive scheduling data via a time sensitive scheduling data delivery network comprises accommodating the management of the display of potentially voluminous time sensitive scheduling data, making all of the relevant time sensitive scheduling data information available from high capacity remote data stores accessible to all of a user's time sensitive scheduling data receiving devices via a time sensitive scheduling data network, and on demand by time sensitive scheduling data display zone category to the user's time sensitive scheduling data receiving devices, and managing dynamically which display zone classes and subclasses of time sensitive scheduling data appear, which time frames appear and how much time sensitive scheduling data appears on the user's time sensitive scheduling data receiving device display screens. Thus, while making decisions or planning the users may overcome current screen real estate and device storage problems. A uniform management process for time sensitive scheduling data flow may occur and both the synchronization and many of the storage related data availability problems may be overcome.

Another embodiment relates to accommodating flow management of passive delivery of time sensitive scheduling data to a time sensitive scheduling data receiving device via the time sensitive scheduling data delivery network.

According to another embodiment, controlling flow of content and receipt of time sensitive scheduling data may further comprise identifying classes of time sensitive scheduling data to receive on the user's time sensitive scheduling data receiving device, receiving time sensitive scheduling data items within that class of time sensitive scheduling data when those items become available and until the activity or observance has expired, and filtering certain time sensitive scheduling data streams dynamically.

In another embodiment of the invention, the resulting method may be general purposed or purposed. For example, in a general purposed embodiment, the user may customize an embodiment of the invention by tuning or adjusting a user's profile. The user's profile is selected from the group consisting of channel subscriptions, designated and derived affiliations, personal observance items, reminder designations, designated and derived areas of interests, biographic data, psycho-graphic data, geographic data, and a combination thereof. Alternatively, in a purposed embodiment of the invention, the time sensitive scheduling data receiving device may be restricted to receiving only certain pre-designated time sensitive scheduling data channels assigned to specific time sensitive scheduling data display zones.

In another embodiment of the invention, the specific time sensitive scheduling data sent and received may be related to activities of at least one of originating organizations, affiliated groups of individuals, and individuals.

In another embodiment of the invention, the specific time sensitive scheduling data stream transmitted may be an aggregation of activities for a specific time frame related to sources comprising at least one of the group of an originating organization, an affiliated group of individuals, and an individual.

In another embodiment of the invention, the specific time sensitive scheduling data stream transmitted may be an aggregation of display classes of time sensitive scheduling data for a specific time frame.

In another embodiment of the invention, the delivery of time sensitive scheduling data via specific time sensitive scheduling data receiving devices may comprise deriving interest for an entity by matching the receiving entity's selections for receiving time sensitive scheduling data based on the receiving entity's definition of what constitutes the specific time sensitive scheduling data display zone classes. The specific time sensitive scheduling data display zone classes are selected from the group consisting of preference items, interest items, informational items, reservations, reminders, logistics items, notices and alerts, and observances.

In another embodiment of the invention, the specific display zone filtered time sensitive scheduling data may be transmitted as at least one item.

Another embodiment of the invention relates to streaming only filtered, time sensitive scheduling data that relates to a specific category of time sensitive scheduling data display zone class.

In another embodiment of the invention, display zone filtered time sensitive scheduling data may be delivered to an entity wherever the entity may be.

Another embodiment of the invention relates to assigning the time sensitive scheduling data channels to the interest items display zone class by using an entity's area of interest to define time sensitive schedule data interest items.

Another embodiment of the invention relates to assigning the time sensitive scheduling data channels to the preference items display zone class by using an entity's affiliations to define time sensitive schedule data preference items.

Another embodiment of the invention relates to assigning the time sensitive scheduling data channels to the reminder display zone class by using a receiving entity's flagged reminders to define time sensitive schedule data reminders.

Another embodiment of the invention relates to assigning the time sensitive scheduling data channels to the reservation display zone class by using a receiving entity's reservations to define time sensitive schedule data reservations.

Another embodiment of the invention relates to assigning the time sensitive scheduling data channels to the notices and alerts display zone class by using an entity's need to know areas to define time sensitive schedule data notices and alerts.

Another embodiment of the invention relates to assigning the time sensitive scheduling data channels to the informational items display zone class by using an entity's affinities to define time sensitive schedule data informational items.

Another embodiment of the invention relates to assigning the time sensitive scheduling data channels to the reminder display zone class by using a receiving entity's flagged reminders to define time sensitive schedule data logistics items.

Another embodiment of the invention relates to assigning time sensitive scheduling data channels to the notices and alerts display zone class by using an entity's affinities to define time sensitive schedule data observances.

In another embodiment of the invention, the time sensitive scheduling data delivery network is a communications network selected from the group consisting of a cellular telephony communications network, a Internet communications network, a broadcast TV/Radio communications network, a satellite communications network, and a combination thereof.

Another embodiment of the invention relates to accommodating the transforming of existing products into new classes of products with dual purposes or restored value based on the enhancing, extending or repurposing the functionality of the product unit.

Another embodiment of the invention may be a purposed display device displaying specific classes of upcoming, relevant and targeted time sensitive scheduling data occurring within a predefined time period of the current time reflected on a time sensitive scheduling data receiving display device. This embodiment may be related to working with the time sensitive scheduling data delivery network. The time sensitive scheduling data purposed display device can display information related to designated areas of interest and/or of specific sources of time sensitive scheduling data to inform viewers of upcoming activities, approaching deadlines, transit status of people or goods, and requested reminders related to upcoming activities and observances.

Another embodiment of the invention relates to enabling a digital clock to display specific classes of upcoming, relevant and targeted time sensitive scheduling data occurring within a predefined time period of the current time reflected on the digital clock.

Another embodiment of the invention relates to enabling a digital picture frame to display specific classes of upcoming, relevant and targeted occurring within a predefined time period of the current time reflected on the digital picture frame.

Another embodiment of the invention relates to enabling a wireless router to display specific classes of upcoming, relevant and targeted time sensitive scheduling data occurring within a predefined time period of the current time reflected on the wireless router.

Another embodiment of the invention relates to enabling a set top receiver to display specific classes of upcoming, relevant and targeted time sensitive scheduling data occurring within a predefined time period of the current time reflected on the set top receiver.

In another embodiment, a system for controlling the flow of content and receipt of time sensitive scheduling data to an entity is described. The system may include a time sensitive scheduling data center for storing user and device time sensitive scheduling data display class preferences, collecting user and device time sensitive scheduling data display class preferences, and sending user and device time sensitive scheduling data display class preferences to a receiving entity, connectivity medium communication interfaces for transmitting user and device time sensitive scheduling data display class preferences between the time sensitive scheduling data center, a communication technology, and a time sensitive scheduling data receiving device, and a communication technology suitable for receiving and sending user and device time sensitive scheduling data display class preferences. The system may also include processors for processing executable instructions for accommodating management of display of potentially voluminous time sensitive scheduling data, making all of relevant time sensitive scheduling data information available from high capacity remote data stores accessible to all of user's time sensitive scheduling data receiving devices via a time sensitive scheduling data delivery network, and on demand by a time sensitive scheduling data display zone category to the user's time sensitive scheduling data receiving devices, and managing dynamically which display zone classes and subclasses of time sensitive scheduling data appear, which time frames appear and how much time sensitive scheduling data appears on user's time sensitive scheduling data receiving device display screens. Finally, the system may also include a time sensitive scheduling data receiving device for receiving and sending user and device time sensitive scheduling data display class preferences to the time sensitive scheduling data center via the connectivity medium communication interfaces via the communication technology.

Another embodiment provides a computer program product executable by a computer processor for processing a controlling flow of content and receipt of time sensitive scheduling data via a time sensitive scheduling data network. The computer product includes computer code for accommodating management of display of potentially voluminous time sensitive scheduling data, computer code for making all of relevant time sensitive scheduling data information available from high capacity remote data stores accessible to all of time sensitive scheduling data receiving devices, and on demand by time sensitive scheduling data display zone category to user's time sensitive scheduling data receiving devices, computer code for managing dynamically which display zone classes and subclasses of time sensitive scheduling data appear, which time frames appear and how much time sensitive scheduling data appears on user's time sensitive scheduling data receiving device display screens, and computer readable-medium for storing the computer code.

Another embodiment provides a computer program product executable by a computer processor for processing a grid flow management system. The computer program product includes computer code for creating a user's session profile, updating a user's session profile, creating specific time sensitive scheduling data based on a receiving entity's time sensitive scheduling data channels, user and device time sensitive scheduling data class preferences, current time, and requested time frame, transmitting time sensitive scheduling data fulfillment requests to time sensitive scheduling data server, receiving time sensitive scheduling data from the fulfillment requests, transmitting time sensitive scheduling data matching parameters to a promotions server, receiving promotional content, formatting all requested time sensitive scheduling data and promotional content, and transmitting time sensitive scheduling data streams to a time sensitive scheduling data receiving device, computer code for updating the time sensitive scheduling data class preferences in authorization record for the receiving entity, transmitting subscriber profile identifier, the receiving entity's time sensitive scheduling data display class preferences, and administrative parameters such as session profile identifier, starting time, and network use limitations, and requesting the receiving entity's subscriber profile from a subscriber profile server, computer code for returning the receiving entity's subscriber profile identifier to the authentication server, computer code for managing the receipt, maintenance, and storage of time sensitive scheduling data, computer code for managing the receipt, maintenance, and storage of promotion content, and computer readable-medium for storing the computer code.

In another embodiment, a grid flow management system is described. The grid flow management system includes a fulfillment server creating a user's session profile, updating a user's session profile, creating specific time sensitive scheduling data based on a receiving entity's time sensitive scheduling data channels, user and device time sensitive scheduling data class preferences, current time, and requested time frame, transmitting time sensitive scheduling data fulfillment requests to time sensitive scheduling data server, receiving time sensitive scheduling data from the fulfillment requests, transmitting time sensitive scheduling data matching parameters to a promotions server, receiving promotional content, formatting all requested time sensitive scheduling data and promotional content, and transmitting time sensitive scheduling data streams to a time sensitive scheduling data receiving device. The grid flow management system also includes an authentication server updating the time sensitive scheduling data class preferences in authorization record for the receiving entity, transmitting subscriber profile identifier, the receiving entity's time sensitive scheduling data display class preferences, and administrative parameters such as session profile identifier, starting time, and network use limitations, and requesting the receiving entity's subscriber profile from a subscriber profile server and the subscriber profile server returning the receiving entity's subscriber profile identifier to the authentication server. In addition, the grid flow management system includes the time sensitive scheduling data server managing the receipt, maintenance, and storage of time sensitive scheduling data. The grid flow management system also includes a promotions server managing the receipt, maintenance, and storage of promotion content, a data store, and time sensitive scheduling data receiving devices.

### BRIEF DESCRIPTION OF THE DRAWINGS

Detailed and specific features of the present invention are more fully disclosed in the following sections, with reference being made to the accompanying drawings, in which:

FIG. 1A is a simplified system diagram of a time sensitive scheduling data delivery network according to one embodiment of the invention;

FIG. 1B is a representation of the time sensitive scheduling data delivery network and device relationships according to one embodiment of the invention;

FIG. 1C is a representation of the time sensitive scheduling data delivery network and device relationships according to one embodiment of the invention;

FIG. 1D is a representation of the time sensitive scheduling data delivery network and device relationships according to one embodiment of the invention;

FIG. 2 is a representation of the location of the functions which apply time sensitive scheduling data display class preferences according to one embodiment of the invention;

FIG. 3A is a flowchart showing the location of the time sensitive scheduling data display class preference filter functions according to one embodiment of the invention;

FIG. 3B is a flowchart showing components involved in the grid flow management method according to one embodiment of the invention;

FIG. 3C is a flowchart of a time sensitive scheduling data grid flow management refresh display data process according to one embodiment of the invention;

FIG. 4A presents the time sensitive scheduling data display zone classes in an embodiment of the invention according to one embodiment of the invention;

FIG. 4B shows the time sensitive scheduling data display zone control switches on a sample display screen according to one embodiment of the invention;

FIG. 4C shows the locations of where time sensitive scheduling data display zone preference filtering is applied within the grid flow management process according to one embodiment of the invention;

FIGS. 5A-5M provide display screen schematics and example time sensitive scheduling data display screens according to one or more embodiments of the invention;

FIG. 6 shows a flowchart of a time sensitive scheduling data grid flow management methods according to one embodiment of the invention;

FIG. 7 depicts attributes for time sensitive scheduling data according to an embodiment of the invention;

FIG. 8 shows primary activity functions of a time sensitive scheduling data fulfillment process according to one embodiment of the invention;

FIG. 9 is a class diagram illustrating classes of target audiences for time sensitive scheduling data according to an embodiment of the invention; and

FIG. 10 is a class diagram illustrating the classes of time sensitive scheduling data activity sources according to an embodiment of the invention.

### DETAILED DESCRIPTION OF THE INVENTION

Reference throughout this specification to “one embodiment” or “an embodiment” means that a particular feature, structure, or characteristic described in connection with the embodiment may be included in at least one embodiment of the present invention. Thus, the appearance of the phrase “in one embodiment” or “an embodiment” in various places throughout this specification does not necessarily refer to the same embodiment. Furthermore, the particular features, structures, or characteristics may be combined in one or more embodiments.

In the following description, for purposes of explanation, numerous details are set forth, such as flow charts and system configurations, in order to provide an understanding of one of more embodiments of the present invention. However, it is and will be apparent to one skilled in the art that these specific details are not required in order to practice the invention.

Accordingly, what is needed is a system to allow the user to dynamically manage what type of activity data appears, what time frame appears and how much activity data appears on their calendaring and scheduling displays.

In one embodiment of the invention, a system is provided that can enable individuals to subscribe to a data stream of future events based on entities or groups that they are affiliated and/or with formal organizations or activities they are interested in monitoring. Further, the system can enable many individuals to take advantage of the recording of time sensitive scheduling data (TSSD) by a single individual anywhere, thereby leveraging the work product of this one individual and reducing the duplication of effort by many other individuals who need/desire the same TSSD. In addition, the system can allow an entity to retrieve individually relevant TSSD of personal interest from many sources repeatedly without ever having to transfer the data to its personal calendaring/scheduling records. In that fashion, a method may be provided for subscribing to the efforts of at least one of creators, providers, and designated recorders of TSSD.

The present disclosure can accommodate the flow management of the passive delivery of TSSD to a TSSD receiving device via a TSSD delivery network. One embodiment of the invention relates to methods for controlling the flow of content and receipt of TSSD and related aspects of the dissemination of TSSD. This may involve accommodating the management of the display of potentially voluminous TSSD. This may also involve making all of the relevant TSSD information available 1) from high capacity remote data stores accessible to all of the TSSD receiving devices, and 2) on demand by TSSD display zone category to the user's TSSD receiving devices. The user may dynamically manage which categories of TSSD appear, what time frame appears and how much TSSD appears on their TSSD receiving device display screens. Thus, while making decisions or planning the users may overcome current screen real estate and device storage problems. A uniform management process for TSSD flow may occur and both the synchronization and many of the storage related data availability problems may be overcome.

In one embodiment of the invention, a user of the TSSD delivery network 1) may identify classes of TSSD to receive on the user's TSSD receiving device, 2) may receive TSSD items within that class of TSSD when those items become available and until the activity or observance has expired, and 3) may filter certain TSSD streams dynamically. TSSD may flow through the TSSD delivery network in TSSD channels based on the originating entity source of the activity. These TSSD channels may be designated as preference items or information items. TSSD may flow through the TSSD delivery network in TSSD channels based on being assigned to an area of interest category; these TSSD channels may be designated as interest items. TSSD may flow through the TSSD delivery network in TSSD channels based on being assigned to an observances category; these TSSD channels may be designated as observance items. TSSD may flow through the TSSD delivery network in TSSD channels based on being part of a logistical chain of events which culminates in a delivery of material or service; these TSSD channels may be designated as logistics items. TSSD may flow through the TSSD delivery network in TSSD channels based on being a reservation event tied to an upcoming delivery of services; these TSSD channels may be designated as reservation items. Preference items, information items, interest items may be transformed by user designation action into reminder items.

In another embodiment of the invention, the resulting method may be general purposed or purposed. For example, in a general purposed embodiment, the user may personalize the invention by tuning or adjusting the user's profile which may include channel subscriptions, designated and derived affiliations, personal observance items, reminder designations, designated and derived areas of interests and biographic/psychographic/geographic data. Alternatively, in a purposed embodiment of the invention, a time sensitive scheduling data receiving device may be restricted to receiving only certain pre-designated time sensitive scheduling data channels assigned to specific time sensitive scheduling data display zones. For example, a TSSD receiving device may be purposed for displaying reservation status at, for example, a restaurant, government agency office or corporate conference room. In another purposed embodiment of the invention, a TSSD receiving device may be tuned to display only the schedule of activities associated with a major special event such as the World Series, World Cup or the Super Bowl.

Another embodiment of the invention relates to accommodating the transforming of existing products into new classes of products with dual purposes or restored value based on the enhancing, extending or repurposing the functionality of the product unit.

Another embodiment of the invention relates to accommodating the enhancing of the functionality of at least one of digital clocks (extended functionality), digital picture frame (repurposed or enhanced functionality) and WIFI-routers (dual purposes) creating new classes of products in their product categories.

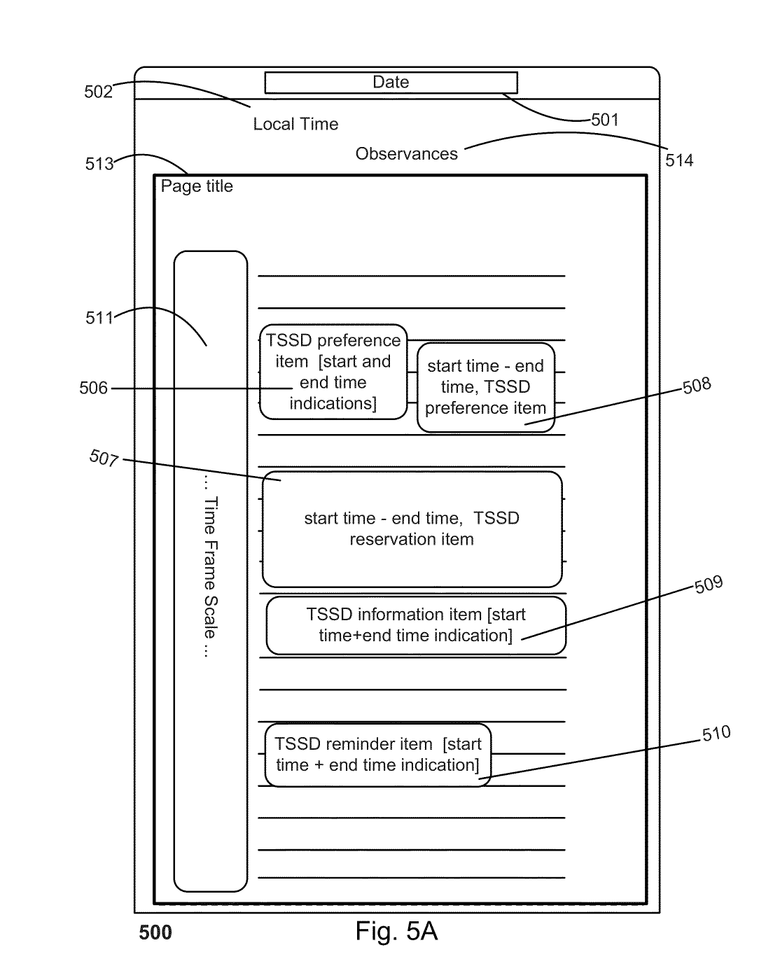

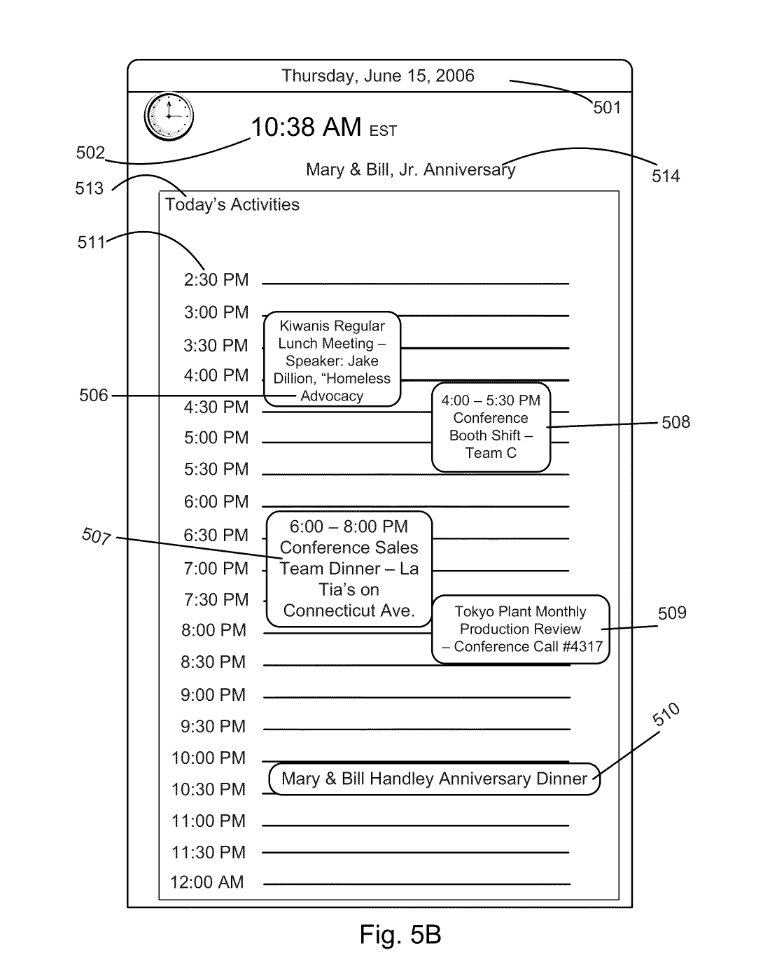

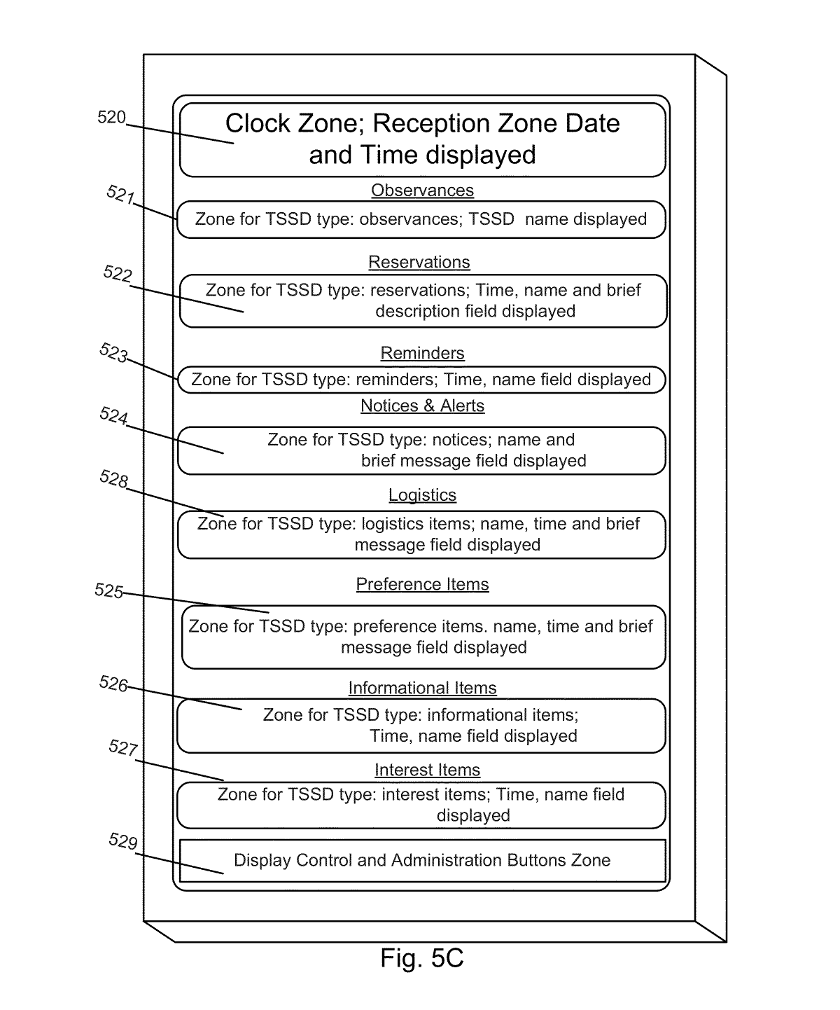

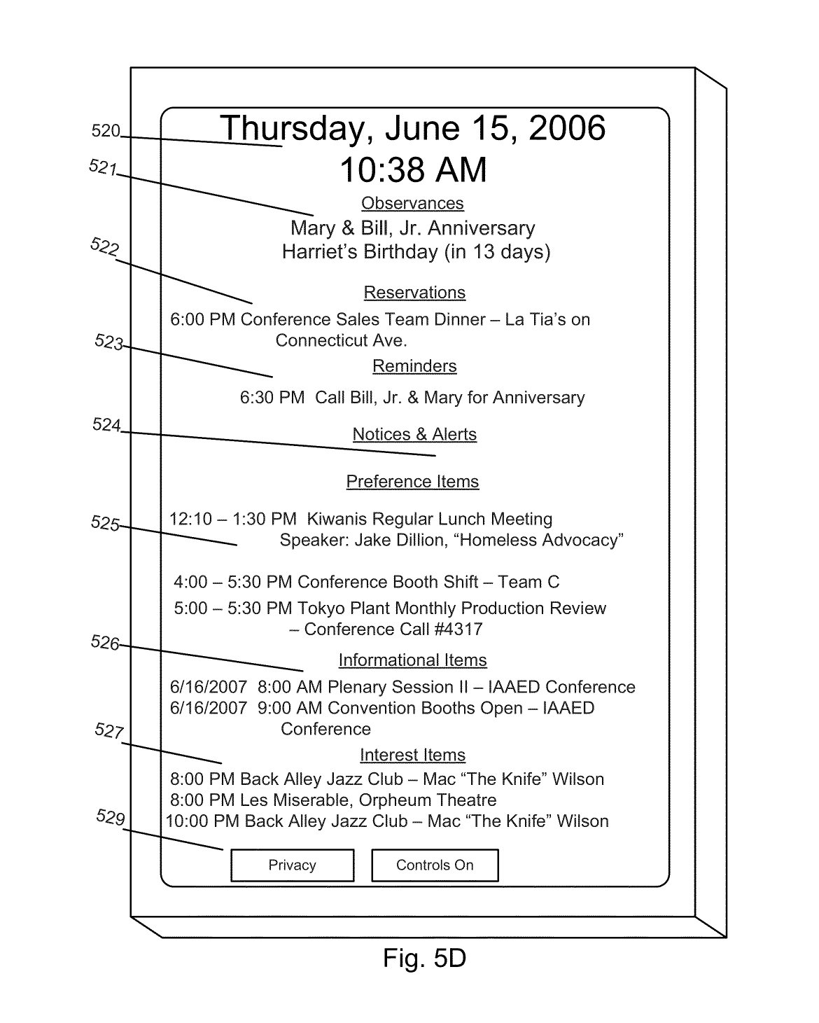

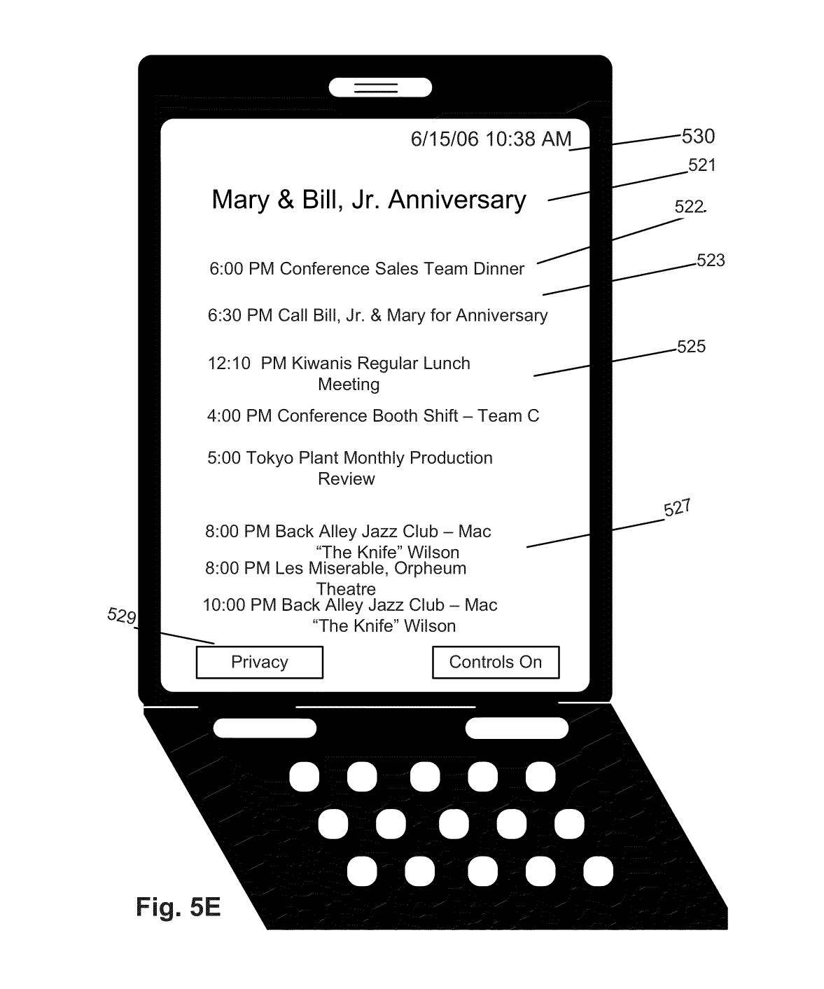

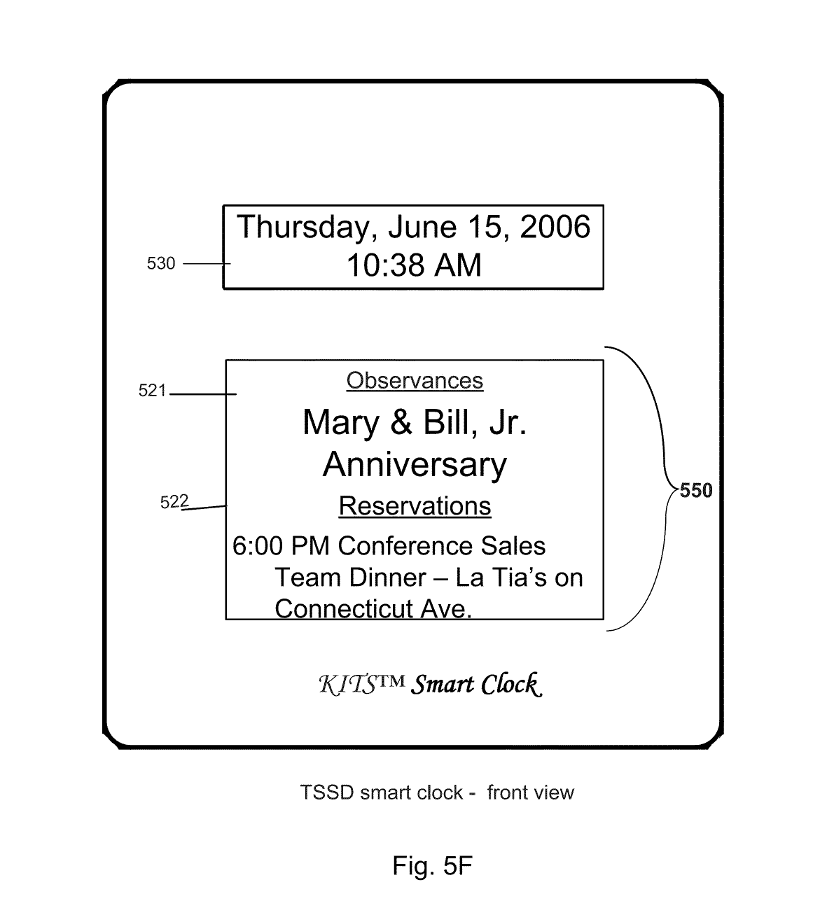

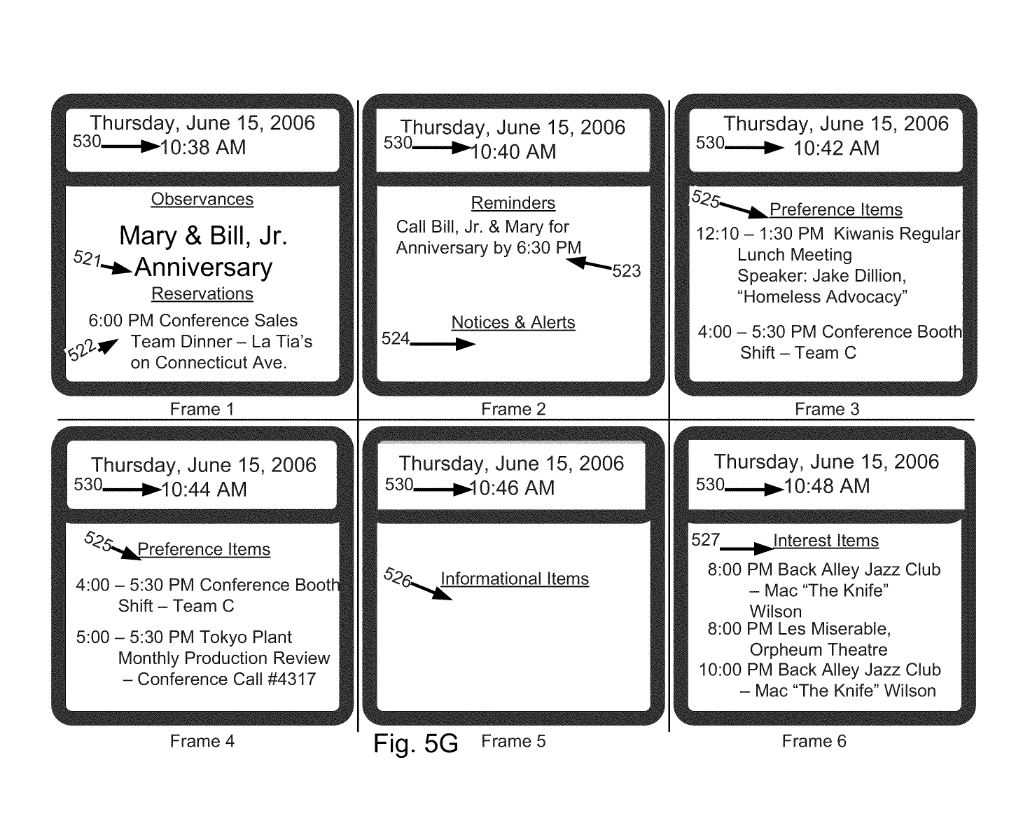

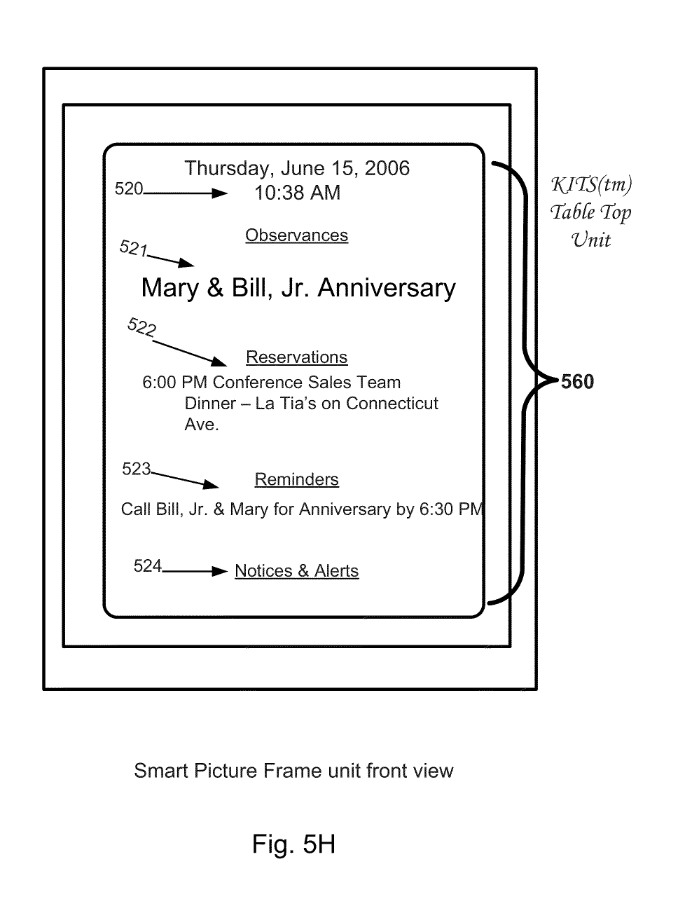

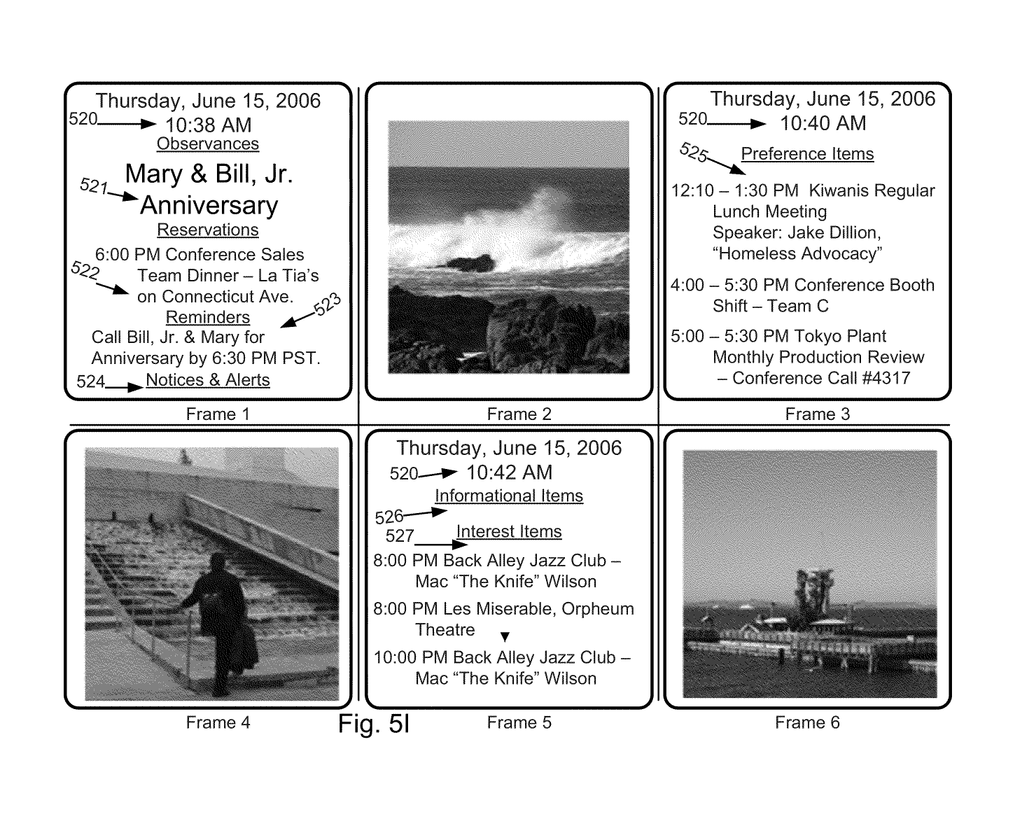

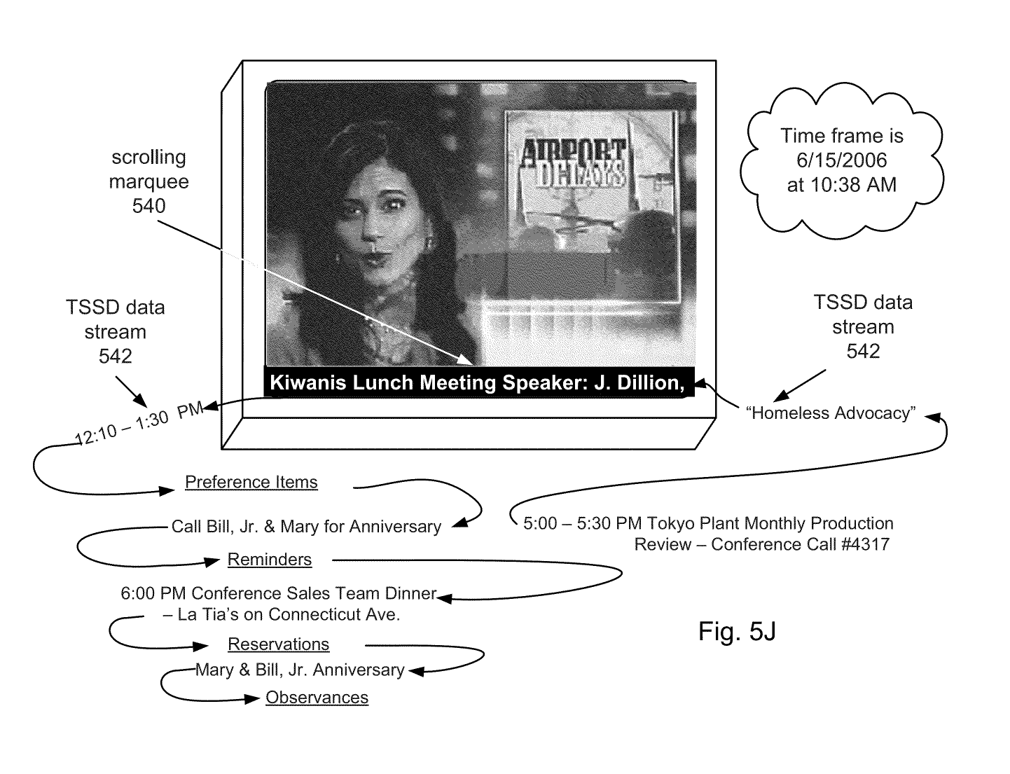

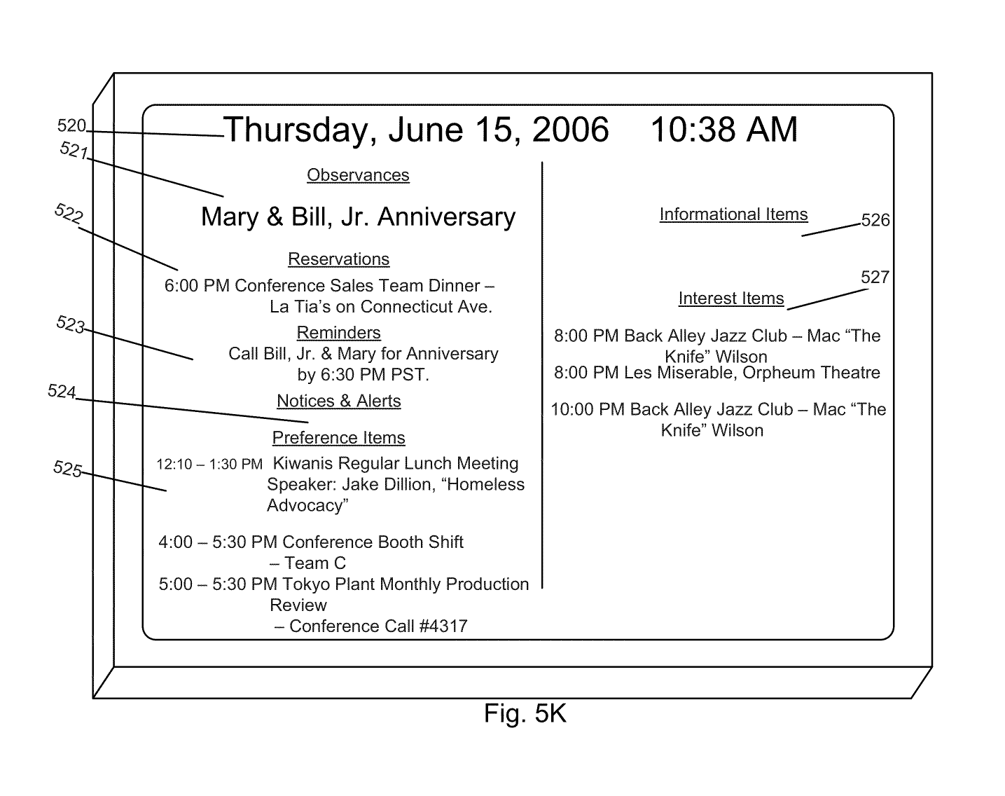

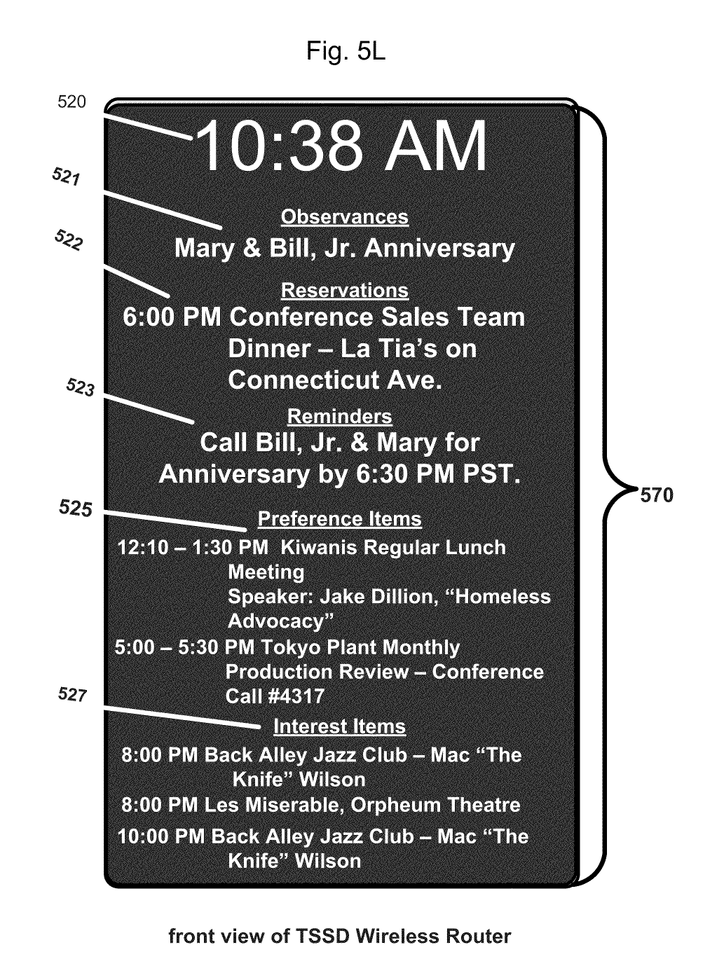

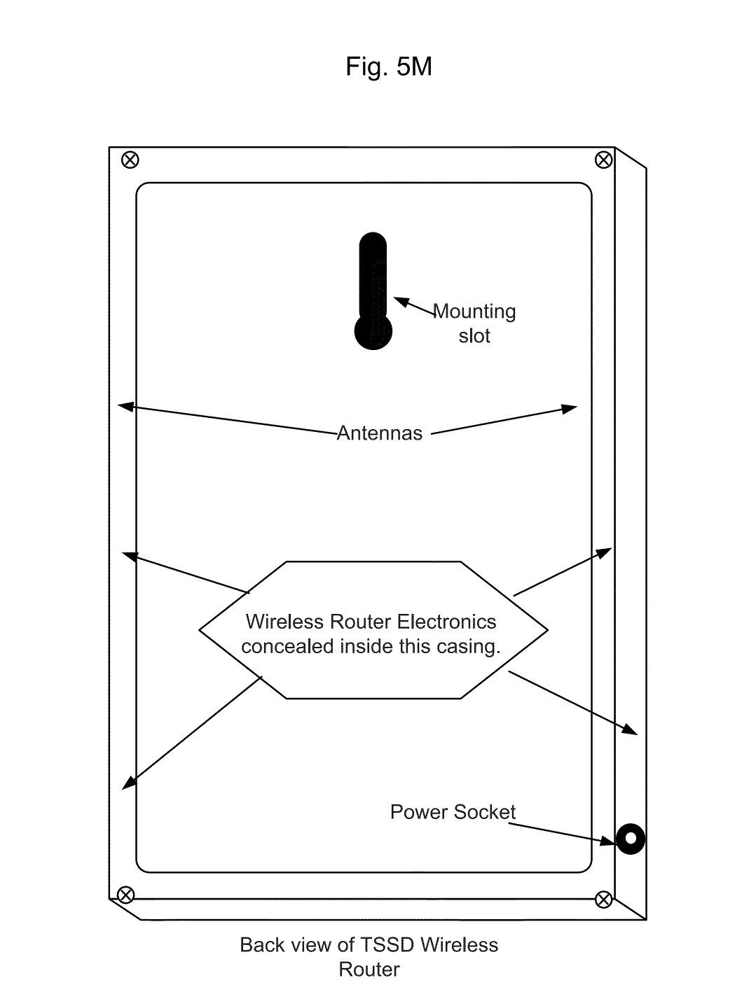

In another embodiment of the invention, an embedded method may be provided which enables a digital clock to receive and display specific classes of upcoming, relevant and targeted TSSD occurring within a predefined time period of the current time reflected on the clock as will be described below in more detail with respect to FIGS. 5F and 5G. Instead of the clock merely displaying the time, the digital clock may display additional information related to designated areas of interest and/or of specific sources of TSSD to inform viewers of for example upcoming activities, approaching deadlines, transit status of people or goods, and requested reminders related to upcoming activities or observances.

Another embodiment of this invention is an embedded method which enables a digital picture frame to display specific classes of upcoming, relevant and targeted TSSD occurring within a predefined time period of the current time as will be described below in more detail with respect to FIGS. 5H and 5I. Instead of the picture frame merely displaying stored images, the digital picture frame may display additional information related to designated areas of interest and/or of specific sources of TSSD to inform viewers of upcoming activities, approaching deadlines, transit status of people or goods, and requested reminders related to upcoming activities or observances.

Another embodiment of this invention is an embedded method which enables a wireless router to display specific classes of upcoming, relevant and targeted TSSD occurring within a predefined time period of the current time reflected as will be described below in more detail with respect to FIGS. 5K and 5L. Instead of the wireless router merely providing routing and related networking services, the wireless router may be disguised as a digital display device and it primary purpose may be centered around displaying information related to designated areas of interest and/or of specific sources of TSSD to inform viewers of upcoming activities, approaching deadlines, transit status of people or goods, and requested reminders related to upcoming activities or observances. The transformed device may now be more strategically located for improved wireless coverage with its enhanced functionality and esthetic presentation.

Another embodiment of this invention may be a purposed display device displaying specific classes of upcoming, relevant and targeted TSSD occurring within a predefined time period of the current time reflected on the device clock connected with the TSSD delivery network. The TSSD purposed display device can display information related to designated areas of interest and/or of specific sources of TSSD to inform viewers of upcoming activities, approaching deadlines, transit status of people or goods, and requested reminders related to upcoming activities or observances.

In the TSSD delivery network the components are a type of activity data referred to as time sensitive scheduling data (TSSD) described herein, a set of functions which encompass the collection, storage, maintenance and orderly dissemination of TSSD, hardware and software which perform these functions and entities which produce and consume TSSD.

### DEFINITIONS

As used in this description and the accompanying claims, the following terms shall have the meanings indicated, unless the context otherwise requires.

“Time sensitive scheduling data (TSSD)” may refer to data relating to the class of entity activities including attending, timely participating, scheduling, planning, organizing, responding and reserving. The TSSD originates from the class of TSSD activity sources including standard events, standard meetings, ad hoc activities, and observances. This TSSD data has high utility and is frequently referenced in its relationship to an individual's continually changing activities. Also such data is not of transitory interest to users, since checking one's schedule is a necessary activity that an individual does numerous times on a daily basis.

“Channel” may refer to a data stream containing one or more “profiled” (selected based on specific criteria which may include affiliation, derived interests, time frame, geographic basis of source and type of TSSD) and prioritized feed packets of content.

“Cloud” may refer to homogeneous groups of cooperating networks which deliver data from a source to a destination via one or more paths that may generally be determined by the cooperating networks components and not by the originating source device or the destination receiving device. It should be appreciated that the path by which the data reaches the source may be unpredictable or unidentifiable in advance.

“Entity” may refer to consuming entities whose actions consume time sensitive scheduling data, producing entities whose activities produce time sensitive scheduling data, providing entities who submit time sensitive scheduling data intended for consumption by other entities, and receiving entities who control what is received and presented on the time sensitive scheduling data receiving device used for consumption of time sensitive scheduling data by entities. The consuming entities may include individual members or affiliates of time sensitive scheduling data delivery network client organizations, interested individuals who browse time sensitive scheduling data network communications site, time sensitive scheduling data delivery network subscribers, members or affiliates of entities displaying time sensitive scheduling data activity feeds, and individuals passing by areas display time sensitive scheduling data activity feeds. The producing entities may include individuals, members of formal organizations, staffs of formal organizations, affiliated groups of individuals, viewers from non-affiliated groups, individuals in common interest groups, and individuals in a common space at the same time. Both the providing entities and receiving entities may include individuals, members of formal organizations, staffs of formal organizations, members of affiliated groups of individuals in non-formal organizations, and individuals in common interest groups.

“Connectivity medium” may refer to a medium (e.g., air, wire, or fiber) between two or more nodes that provides a communication network with a channel. In the present disclosure the connectivity medium may function as a channel that communicates the required request, credentials, and keys that allow for the movement of TSSD.

“Display Zone” may refer to a purposed area of a display screen. A purposed area may be an area designated or dedicated for specific uses or the display of specific categories of information.

“Distribute TSSD” may refer to the streaming of TSSD data to TSSD receiving devices when a specific profile match or a specific affiliation match is present or the receiving entity is known to the TSSD providing entity.

“Disseminate TSSD” may refer to the streaming of TSSD data to TSSD receiving devices when a specific profile match or a specific affiliation match may not be present or the receiving entity is unknown to the TSSD provider.

“Feed” may refer to a data stream containing one or more specific categories of content. Individual units of content may be designated as feed packets or payloads. Each feed may comprise a set of rules for pulling TSSD out of the data store.

“Need to Know data” may refer to data pertaining to activities or events which impact the health and safety of an individual, a community's members, an individual's relations or a specific group of individuals. Need to know time sensitive scheduling data may include activities which are generally non-routine, unscheduled or unplanned activities. Need to know time sensitive scheduling data may be data such as the occurrence of a natural disaster and its related recovery activities: opening of shelters, delivery schedule of food, water and supplies, and opening of relief services offices. Other examples may include road opening and closing schedules, school or public service office opening and closing schedules,

“Network” may refer to groups of computers, terminals, phones, cameras, and linking communications devices which may include routers, switches, hubs, antennas, and relays linked by wired or wire-less telecommunications systems for the purpose of exchanging data. Network as used herein may generally refer to a group of devices working together for a specific purpose involving the exchange of data.

“Server” may refer to any combination of computer hardware or dedicated computing device(s) and software which has one of its functions the collection, storing, aggregation, packaging and/or dissemination of a specific class of data upon request. In one embodiment, a combination which includes a server may be based on the homogenous data or data formats that are extracted from storage manipulated if necessary by some set of rules or policies and “served up” upon request from one or more entities or functions which consume the data to perform its processes. A single computer may host (provide) several server functions and a single server function may be hosted (shared/provided) by more than one computer or dedicated computing device.

An “activity acquisition” server may refer to a server which functions to harvest, aggregate and/or manipulate TSSD activity data.

An “organization-managed” activity acquisition server may refer to a an activity acquisition server where the activity data harvested by such server may have been created and maintained on the server by any or all members of the organization providing the activity data and the organization takes responsibility for the content of the activity data (e.g., activity name, description, activity date, activity time, activity location, attendee policy and fees).

An “individual-managed” activity acquisition server may refer to an activity acquisition server where the activity data harvested by such server is either 1) is the activities of others, i.e., not originated by the individual, but is recorded and maintained on the server by the individual providing the activity data or 2) is the personal activities of individual and the individual takes responsibility for the content of the activity data (e.g., activity name, description, activity date, activity time, activity location, attendee policy and fees).

A “foreign activity acquisition server” may refer to an activity acquisition server where the activity data harvested by such server is the activities not of the providing organization, but of others, i.e., not originated by the organization providing the data. The activity data may be recorded, but not maintained on the server by the organization providing the activity data.

“Site” may refer to a reception zone for the receipt of TSSD that is cross-platform and cross-technology (e.g. web, handheld mobile devices, TV, kiosks, cellular phones, and other similar devices).

“Reception Zone” may refer to the physical and geographic location where TSSD is received. This a relative reference used to provide a reference point for evaluating the time attributes (start time, end time, start date and end date) associated with TSSD activities.

“Reception Time Zone” may refer to the local time zone where TSSD is received. A relative reference may be used to provide a reference point for evaluating the time attributes (start time, end time, start date and end date) associated with TSSD activities. The reception time zone is not strictly equivalent to Coordinate Universal Time Zones or Greenwich Mean Time Zones as it may reflect local customs or local government adjustments in places where these standards have not been adopted or universally followed.

“Transmit” may refer to a means to transfer data from one device to another device via one or more communications protocols, one or more communications media and one or more communication applications which facilitate the transfer of data across communications media by implementing one or more communications protocols. In an embodiment of the invention, TSSD and related collateral data can be transmitted via email, http protocol to a host browser over the Internet, via cellular or other telephony text messaging systems, via voice over a telephony network, over broadcast systems for radio, TV, cable and satellite and over evolving systems for extending the internet: Wi-Fi networks, public utility electrical systems, fiber optic communications systems, microwave communications, photoelectric communication system and wired local area networks.

The TSSD delivery network may include portable display TSSD receiving devices selected from the group including at least one of mobile computing devices, PDAs, cellular phones, personal computers, portable workstations, and a combination thereof.

The TSSD delivery network may include fixed placement display TSSD receiving devices in display locations selected from the group comprising public place business display screens, home entertainment appliance display screens, business display screens in a public place, business display screens on company property in public areas, business display screens on company property in private areas, and a combination thereof.

The TSSD delivery network may also include linked devices in the fixed placement display time sensitive scheduling data receiving devices selected from the group comprising computers that run a single function TSSD delivery network access software product, computers that run browsers linked into a time sensitive scheduling data display website, computers that run a time sensitive scheduling data tuner and display software, set top tuners for home entertainment appliances, stand alone tuners with web access, and a combination thereof.

The present invention can be implemented in various different forms, including but not limited to, at least one of business processes, computer implemented methods, computer program products, computer systems, and communication networks, user interfaces, application programming interfaces, and the like.

The communications network may include at least one of simple devices, advanced devices, individual access devices, and community access devices.

The simple device may be a low-end price competitive device that receives TSSD. It may be able to send a Yes/No indicator in response to something on the device screen. The simple device may also receive TSSD based on who the user is and/or what the interest profile is of the user.

The aforementioned advanced device may have all the capabilities of the simple device plus some additional communications capabilities. By way of example, such an advanced device may have a full two-way interactive device. Some of its features may include a larger screen and easy manipulation of on-screen information. The advanced device may come in various sizes and shapes and changes where people may go to get critical information at several points during their day. The embedded systems devices may include cellular phones, PDAs, mobile digital assistants with cellular phones, text messaging devices and PDAs and Java (MIDP-mobile information device profile) enabled devices, multifunction wristwatches, and handheld computing devices.

The individual access devices such as a laptop computer, desk top computer, cellular phone, and PDA and may allow a single user to receive TSSD into a reception zone, often, but not always, in a web browser format. These individual access devices typically already have a web browser capability built-in. One of the access devices in this category may be a web browser with a special web interface that is designed to receive TSSD. This mimics the advanced device functions somewhat, except as a web application. Another access device may be a cellular phone using the web interface that is now available in many mid-to-high end cellular phones. Another access device may be a PDA using the internet interface that is available now in cellular or Wi-Fi connected PDA devices. It may be appreciated that other embedded systems devices can use non-web integration and/or non-internet integration using alternative communication technologies.

The community access devices may allow multiple users to receive TSSD into a reception zone, often in a web browser type format. One of the access devices in this category may be a set top box, for example. The set top box may use the web interface and keyboards that are available with some set top box vendors such as in-home TV access to TSSD. Another reception zone is a kiosk which may provide activity data shown in a communal or public area. Vertical kiosk applications may come out of this area with payment structures such as from a sponsor paying to the public user paying. In some parts of the world, this is a substitute for a local or regional newspaper or a way to check on government services without a long wait in lines. A third community reception zone can be a broadcast channel which may allow the user to receive TSSD into a reception zone on a broadcast media channel the user is watching. These are zones of traveling message data strips on cable channels or more standalone captive areas like airport system screens. The scrolling TSSD seen there can be based on location and the business function at that location. The media types for these streams may be varied and include internet protocol, telephony, and both on-air cable and private cable.

In a pure push system, content may be streamed to a user as determined by the provider. The user has the option of consuming (i.e., viewing, listening, or feeling) the content or ignoring the content. In one modified push system, the user may have the option to block (filter) unwanted content and the provider cannot override the consumer's choice not to receive specific types of content.

In a pure pull system, a user can request specific available content and the content may be streamed to the user's receiving device for consuming (i.e., viewing, listening, or feeling). In one modified pull system, the user may request a category of content or specific personal content, but the provider has the option to target specific consumers and thereby filter what is streamed to a user. In that fashion, the user cannot override the provider's choice not to stream content to the specific user. For example, a provider may chose to limit content to adults 26 years of age and over and the content will not be delivered users whose profile indicates that they are below the designated age.

According to another embodiment, private TSSD may be activity content provided by the ultimate consumer of the TSSD for that consumer's private use. There may not be an intent for this information to be shared with other entities with the possible exception of family members, i.e., pushed on TSSD channels. When a user is streamed their private TSSD, only TSSD display zone category filtering may be applied.

In another embodiment, public TSSD may be activity content provided with the intent of this content being consumed (i.e., viewed, heard, or felt) by affiliated or subscribed entities. The intent may be to inform others by providing this content for distribution to affiliated entities.

In another embodiment, a privacy circle may be a set of one or more entities designated by a private TSSD provider to be treated as a proxy or the same as the entity providing the private TSSD content. Thus, entities of a privacy circle can inherit the same attributes and a status as the TSSD provider with regards to the specific channel in which that private TSSD is streaming.

In one embodiment, the TSSD fulfillment process functions may include: 1) obtaining a list of channels; 2) selecting channels; 3) sending device and user identifiers, and subscription request; 4) storing authorization and decoding keys; 5) requesting a TSSD channel stream; and/or 6) displaying a TSSD channel stream.

According to another embodiment, the TSSD fulfillment process may involve both a modified push system in which content is sent to the user, and a modified pull system in which the user requests the content details or opens a gateway to new TSSD content. At any given moment a user may be receiving pushed content from one or more channels streams based on the list of channels which the user has authorized, i.e., chosen to monitor. In addition, the same user maybe receiving pushed content which is sponsoring the chosen channel or content which is targeted at the channel.

In the TSSD fulfillment process, the type of data collected from providers and streamed to consumers may be public or private. In the modified push system, the public TSSD content comes filtered by, for example, TSSD profile category, region purchased and jurisdiction purchased. The private data is streamed unfiltered, but targeted only to the user or their designated privacy circle. In the modified pull system, the requested private TSSD content detail may be returned to its user or their designated privacy circle, but may be blocked from streaming to any other requesting entity. In the modified pull system the requested public TSSD content detail may be returned if the requestor's profile or affiliation meets the targeting criteria of the public TSSD content provider.

In an embodiment of the TSSD fulfillment process, communications network based passive delivery of time sensitive scheduling data to an entity may include transmitting via the communications network specific requested TSSD display class preferred data streams aggregated from multiple originating organizations, affiliated groups of individuals, and individual sources to the entity based on an entity's TSSD display zone preferences.

In an embodiment of the TSSD fulfillment process, communications network based passive delivery of time sensitive scheduling data to an entity may include distributing and disseminating time sensitive scheduling data which automatically provides requesting entities with the requested time sensitive scheduling data display category data of personal interest to facilitate timely attendance and participation in a designated area of interest of the entity.

In an embodiment of the TSSD fulfillment process, communications network based passive delivery of time sensitive scheduling data to an entity may include distributing and disseminating time sensitive scheduling data which may automatically provide requesting entities with the requested time sensitive scheduling data display category data of personal interest to facilitate timely attendance and collaboration in a designated area of affiliation of the entity.

In an embodiment of the TSSD fulfillment process, communications network based passive delivery of time sensitive scheduling data to an entity may comprise distributing and disseminating time sensitive scheduling data which may automatically provide requesting entities with the requested time sensitive scheduling data display category data of personal interest to facilitate timely attendance at a designated reservation activity.

In an embodiment of the TSSD fulfillment process, communications network based passive delivery of time sensitive scheduling data to an entity may include distributing and disseminating time sensitive scheduling data which automatically provides requesting entities with the requested time sensitive scheduling data display category data of personal interest to facilitate timely awareness, follow up activity, participation, attendance or collaboration in a designated reminder noticed activity.

In an embodiment of the TSSD fulfillment process, communications network based passive delivery of time sensitive scheduling data to an entity may include distributing and disseminating time sensitive scheduling data which automatically provides requesting entities with the requested time sensitive scheduling data display category data of personal interest to facilitate timely activity and collaboration in a designated need to know activity.

In an embodiment of the TSSD fulfillment process, the requested time sensitive scheduling data display category data may include specific time sensitive scheduling data aggregated from formal organizations, associated groups of individuals, or specific individuals distributed directly to a known entity which has a known interest in the requested time sensitive scheduling data display category data generated.

In an embodiment of the TSSD fulfillment process, the requested time sensitive scheduling data display category data may include specific time sensitive scheduling data aggregated from formal organizations, associated groups of individuals, or specific individuals distributed directly to a known entity which has an unrealized interest in the requested time sensitive scheduling data display category data generated.

In an embodiment of the TSSD fulfillment process, communications network based passive delivery of requested time sensitive scheduling data display category data to a requesting entity may include distributing time sensitive scheduling data to targeted entities based on affiliations between the targeted entities and based on targeted entities profiles.

In an embodiment of the TSSD fulfillment process, communications network based passive delivery of requested time sensitive scheduling data display category data to a requesting entity may include distributing time sensitive scheduling data to targeted entities based on affiliations between the targeted entities.

In an embodiment of the TSSD fulfillment process, communications network based passive delivery of requested time sensitive scheduling data display category data to a requesting entity may include distributing time sensitive scheduling data to targeted entities based on targeted entity profiles.

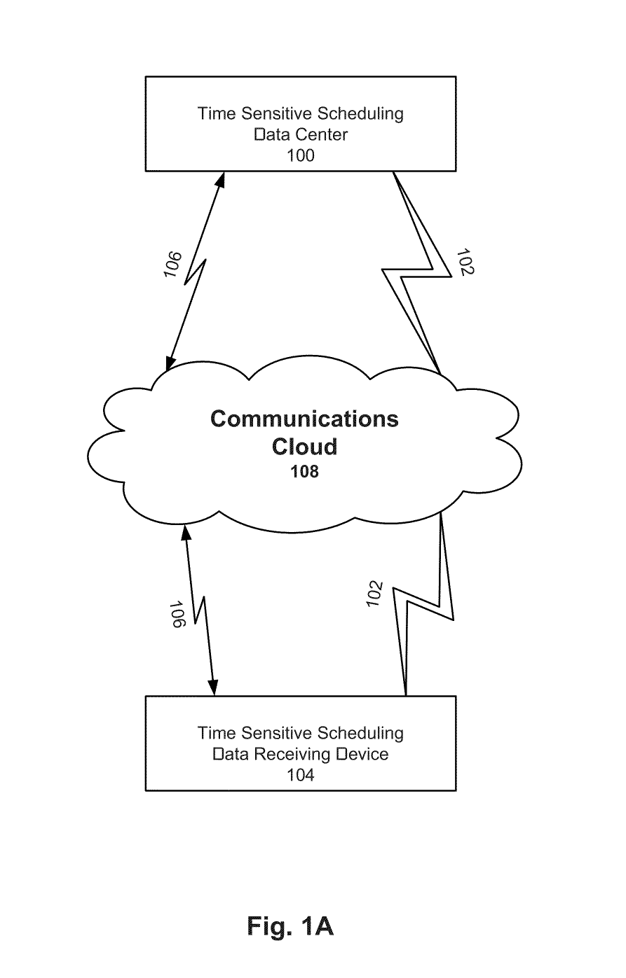

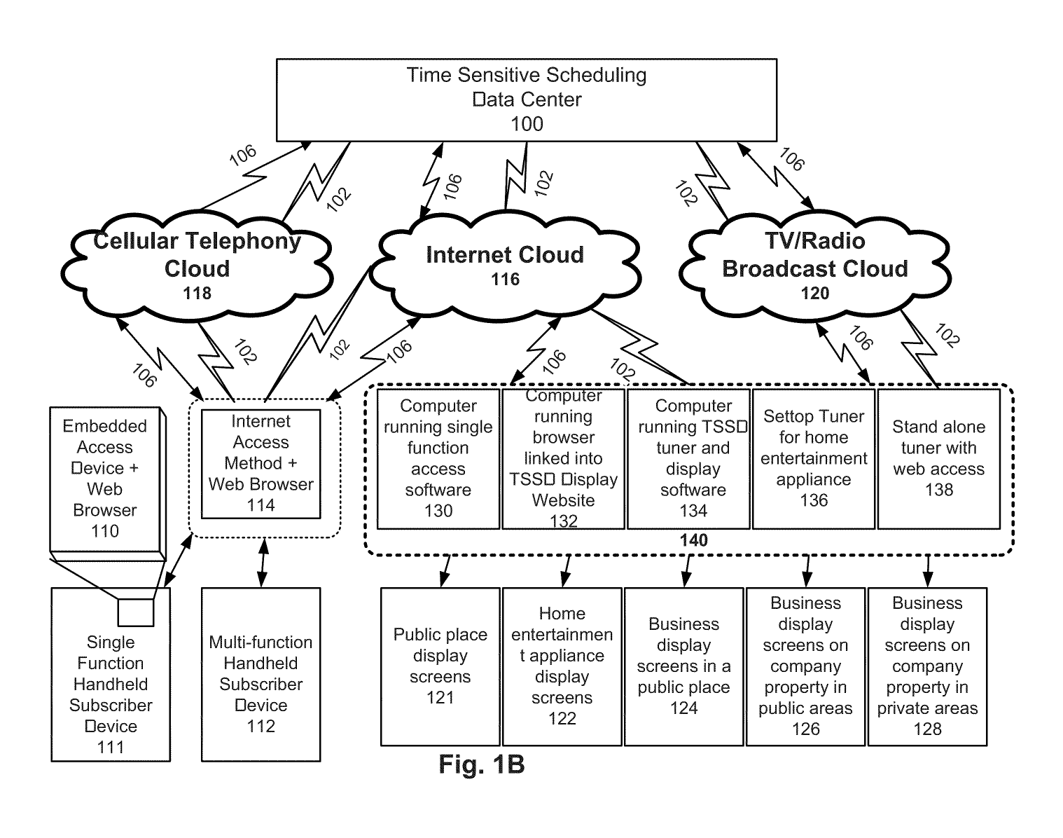

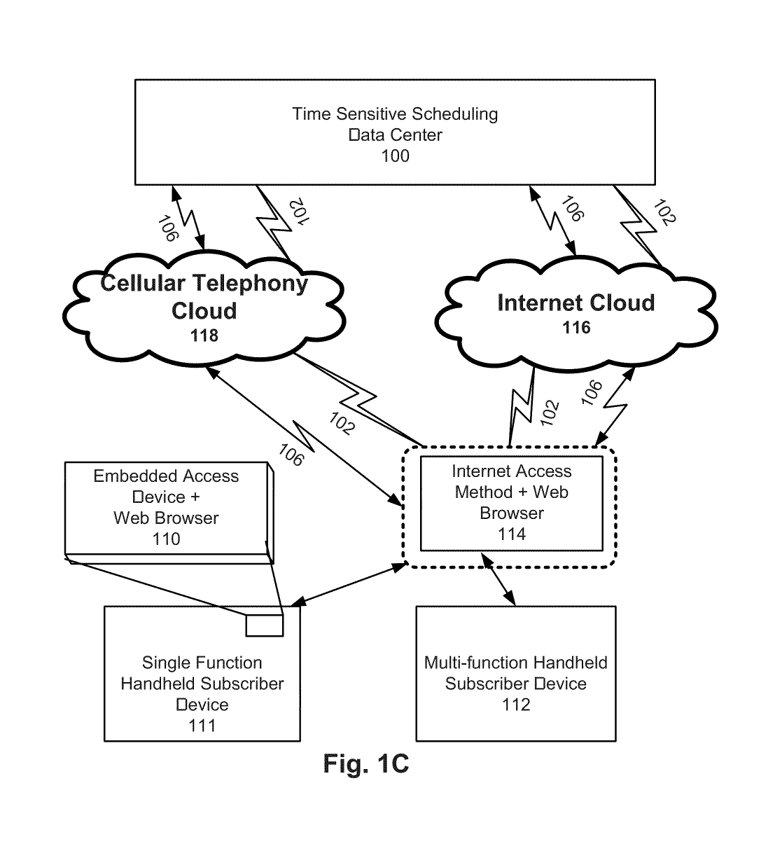

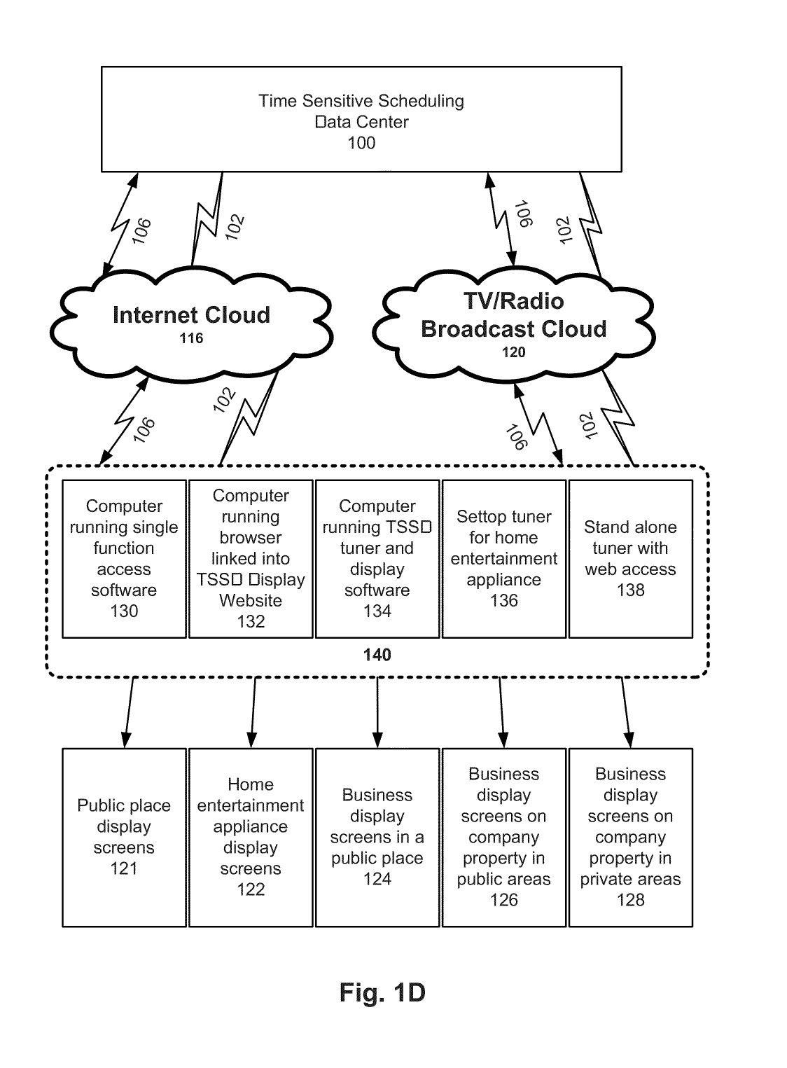

FIG. 1A is a simplified schematic of a communications network configured in accordance with the principles of one embodiment of the invention. In the embodiment of FIG. 1A, a TSSD center 100 collects and stores TSSD via a connectivity medium 102. A TSSD receiving device 104 may then transmit authentication information to the TSSD center 100, via a connectivity medium 106, to a communications cloud 108. The authentication information may contain a subscription fulfillment request, and credentials which include location information (Internet Protocol (IP) address, media access control (MAC) address, mobile identification number (MIN), electronic serial number (ESN), Box ID, subscription channel ID, subscriber ID, or similar ID uniquely identifying the TSSD receiving device 104), and authorization and decoding encryption keys.

The TSSD center 100 may then validate the user's subscription fulfillment request and credentials received from the communications cloud 108 via the connectivity medium 106. If the credentials are valid, the TSSD via the connectivity medium 102 may be returned to the TSSD receiving device 104 through the communications cloud 108. If the credentials are invalid, a rejection message may be transmitted to the TSSD receiving device 104, via the connectivity medium 106, through the communications cloud 108. The TSSD center 100 streams the TSSD via the connectivity medium 102 related to an organization's, association's, and individual's events, activities, and meetings.

FIG. 1B is a representation of the communications network and device relationships configured in accordance with the principles of one embodiment of the invention. In the embodiment of FIG. 1B, the communications cloud 108 includes a cellular telephony cloud 118, an Internet cloud 116, and a TV/Radio broadcast cloud 120 and wherein portable display TSSD receiving devices may include a single function handheld subscriber device 111 and a multifunction handheld subscriber device 112 and fixed placement display TSSD receiving devices 140 may include a public cathode ray tube (CRT), liquid crystal display (LCD), or similar display device such as an electronic billboard, kiosk, or other large screen display.

One type of portable display TSSD receiving device may include the single function handheld subscriber device 111 containing an embedded access device and web browser 110 (software and hardware) which may display user functions available to the user, may carry out communications functions, may transmit requests for authorization, may receive authentication information and TSSD, and may display messages or results of the requests. Another type of portable display TSSD receiving device may include the multifunction handheld subscriber device 112 containing the Internet access method and web browser 114 (software and hardware) that may allow the user to connect to the TSSD center 100. The TSSD center 100 can stream TSSD via the connectivity medium 102 related to affiliated organizations', associations', and user's events, activities, and meetings. The multifunction handheld subscribing device 112 may provide the TSSD center 100 with authentication information based on user input, and received authorization keys. This device may communicate with the TSSD center 100 via a system of computers, switches, routers, trunks, and other network devices which may include Internet cloud 116, or via the cellular telephony cloud 118.

The multifunction handheld subscriber device 112 may include a PDA, cellular phone, or personal computer, or other similar device. The portable display TSSD receiving devices may connect to the TSSD center 100 via the Internet access method and web browser 114, which may include wireless fidelity (Wi-Fi) link, cellular phone service, local access network (LAN), broadband link, or other similar methods, and an Internet service provider's (ISP) services.

The portable display TSSD receiving devices may transmit authentication information to the TSSD center 100, via the connectivity medium 106, to the Internet cloud 116 or the cellular telephony cloud 118. The authentication information may contain a subscription fulfillment request and credentials, which may include identification and location information (some or all of the following: IP address, MAC address, MIN, ESN, Box ID, subscription channel ID, subscriber ID, or similar ID uniquely identifying the receiving devices and geographic position), and authorization and decode encryption keys.

The TSSD center 100 can validate the user's subscription fulfillment request and credentials received from the Internet cloud 116 or the cellular telephony cloud 118 via the connectivity medium 106. If the credentials are valid, the TSSD via the connectivity medium 102 may be returned to the portable display TSSD receiving devices, via the connectivity medium 102, through the Internet cloud 116 or the cellular telephony cloud 118. If the credentials are invalid, a rejection state may be transmitted to the portable display TSSD receiving devices, via the connectivity medium 106, through the Internet cloud 116 or the cellular telephony cloud 118.

According to another embodiment, the fixed placement display TSSD receiving devices 140 may provide display locations which may include public place display screens 121, home entertainment appliance display screens 122, business display screens in a public place 124, business display screens on company property in public areas such as a lobby 126, or business display screens on company property in private areas such as an office or factory floor 128. The fixed placement display TSSD receiving devices 140 may contain computer access devices and similar devices (software and hardware) which display user functions available to the viewer, carry out communications functions, transmit and may receive requests for authorization and TSSD and display messages or results of the requests. The computer access devices in the fixed placement display TSSD receiving devices 140 may include computers that run the single function access software 130, computers that run browsers linked into a TSSD display website 132, computers that run a TSSD tuner and display software 134, set top tuners for home entertainment appliances 136, stand alone tuners with web access 138, or other similar devices. The fixed placement display TSSD receiving devices 140 may link to the TSSD center 100 via communication systems which may include Wi-Fi link, cellular phone service, phone dial-up, radio frequency (RF), LAN, broadband link, satellite, or similar methods.

The fixed placement display TSSD receiving devices 140 may transmit authentication information to the TSSD center 100, via the connectivity medium 106, to the Internet cloud 116 or a TV/Radio Broadcast cloud 120. The authentication information may contain a subscription fulfillment request and credentials, which may include identification and location information (some or all of the following: IP address, MAC address, MIN, ESN, Box ID, subscription channel ID, subscriber ID, or similar ID uniquely identifying the receiving devices and geographic position), and authorization and decode encryption keys.

The TSSD center 100 may then validate the user's subscription fulfillment request and credentials received from the Internet cloud network 116 or the TV/Radio Broadcast cloud 120 via the connectivity medium 106. If the credentials are valid, the TSSD may be returned to the receiving devices, via the connectivity medium 102, through the Internet cloud 116 or the TV/Radio Broadcast cloud 120. If the credentials are invalid, a rejection state may be transmitted to the fixed placement TSSD receiving devices 140, via the connectivity medium 106, through the Internet cloud 116 or the TV/Radio Broadcast cloud 120.

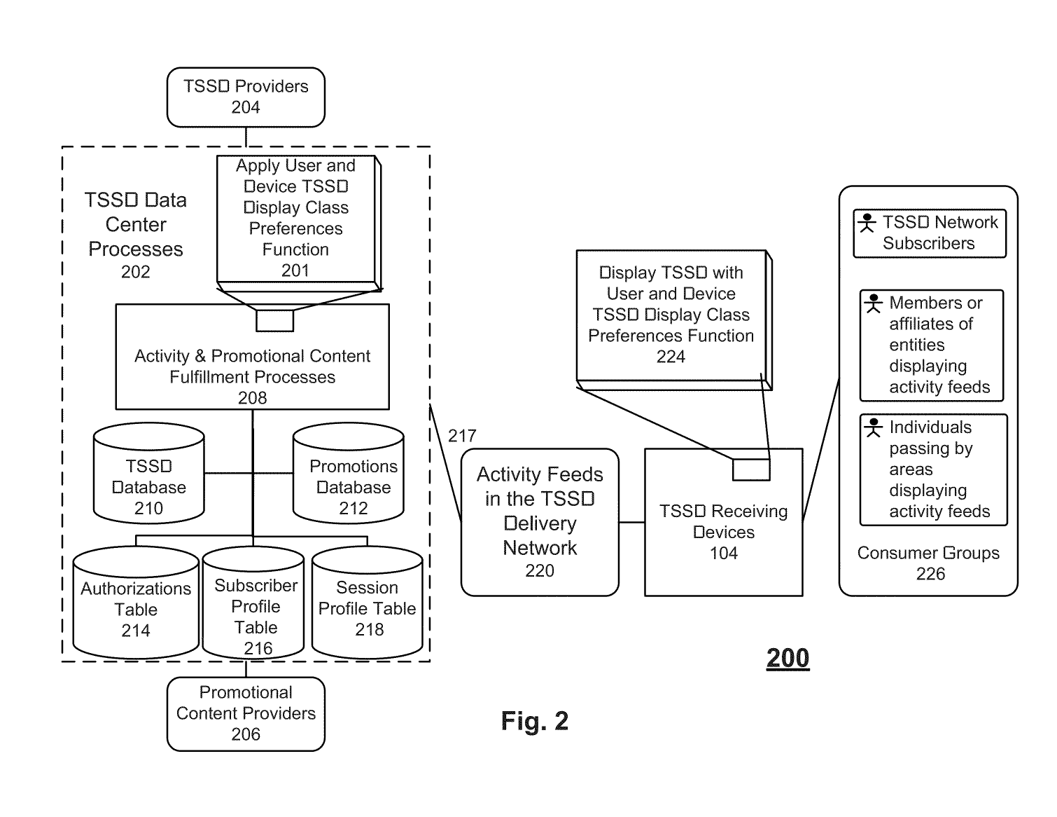

FIG. 1C is a representation of the communications network and device relationships configured in accordance with the principles of one embodiment of the invention relating to the portable display TSSD receiving devices. In the embodiment of FIG. 2, the users may have access to TSSD streams wherever and whenever they may have possession of subscriber devices 111, 112 which may have connectivity to the TSSD center 100 via the Internet connectivity mediums 106 and 102, and may have access via the Internet cloud 116 and/or the cellular telephony cloud 118. The portable display time sensitive scheduling data receiving devices may include a single function handheld device with embedded mechanisms for accessing the communications network and a multifunction handheld device which may include the ability to access the communications network as one of its functions.

FIG. 1D is a representation of the communications network and device relationships configured in accordance with the principles of one embodiment of the invention relating to the fixed placement display TSSD receiving devices. The embodiment of FIG. 1D may be any display screen fixed location 121, 122, 124, 126, 128 in combination with any TSSD receiving mechanism 130, 132, 134, 136, 138. The fixed placement display time sensitive scheduling data receiving devices may include a public cathode ray tube, liquid crystal display, or similar display device such as an electronic billboard, kiosk, or other large screen display. The method of communication may include an Internet access method and web browser, a broadcast data transfer method, a cable media data transfer method or a cellular data transfer method.

FIG. 2 is a representation of the TSSD delivery network and location of the functions which apply TSSD display class preferences to accommodate TSSD data flow management across the TSSD delivery network grid according to one embodiment of the invention. FIG. 2 is a representation of one embodiment of a TSSD delivery communications system 200 showing the location of the TSSD display class preference processing functions in the TSSD delivery network. In this embodiment, non-private activity content from TSSD Providers 204 may be maintained in the TSSD Database 210 and private activity content from TSSD Providers 204 may be maintained in the Authorizations Table 214 by TSSD Data Center Processes 202. Promotional content from Promotional Content Providers 206 may be maintained in the Promotions Database 212 by TSSD Data Center Processes 202. When users in TSSD Consumer Groups 226 initiate sessions TSSD Receiving Devices 104, the Activity & Promotional Content Fulfillment Processes 208 may extract and transmit via line 217 activity and promotional content which will appear on TSSD Receiving Devices 104. In one embodiment of the invention, TSSD may be requested by entities in consumer groups 226. Either “filtered” TSSD may arrive and may be displayed on TSSD Receiving Devices 104 based on the Activity and Promotion Content Fulfillment Processes 208 having applied a function to apply User and Device TSSD Display Class Preferences Function to TSSD 201 before transmission via line 217, or Activity Feeds in the TSSD Delivery Network 220 may arrive at the TSSD Receiving Devices 104 unfiltered and may be converted to filtered TSSD prior to displaying the content by an embedded Display TSSD with User and Device TSSD Display Class Preferences Function 224. The Apply User and Device TSSD Display Class Preferences Function 201 and Display TSSD with User and Device TSSD Display Class Preference Function 224 may apply filtering for a given session based on channel subscriptions stored in the Authorizations Table 214 and user preferences stored in the Subscriber Profile Table 216 and Session Profile Table 218.

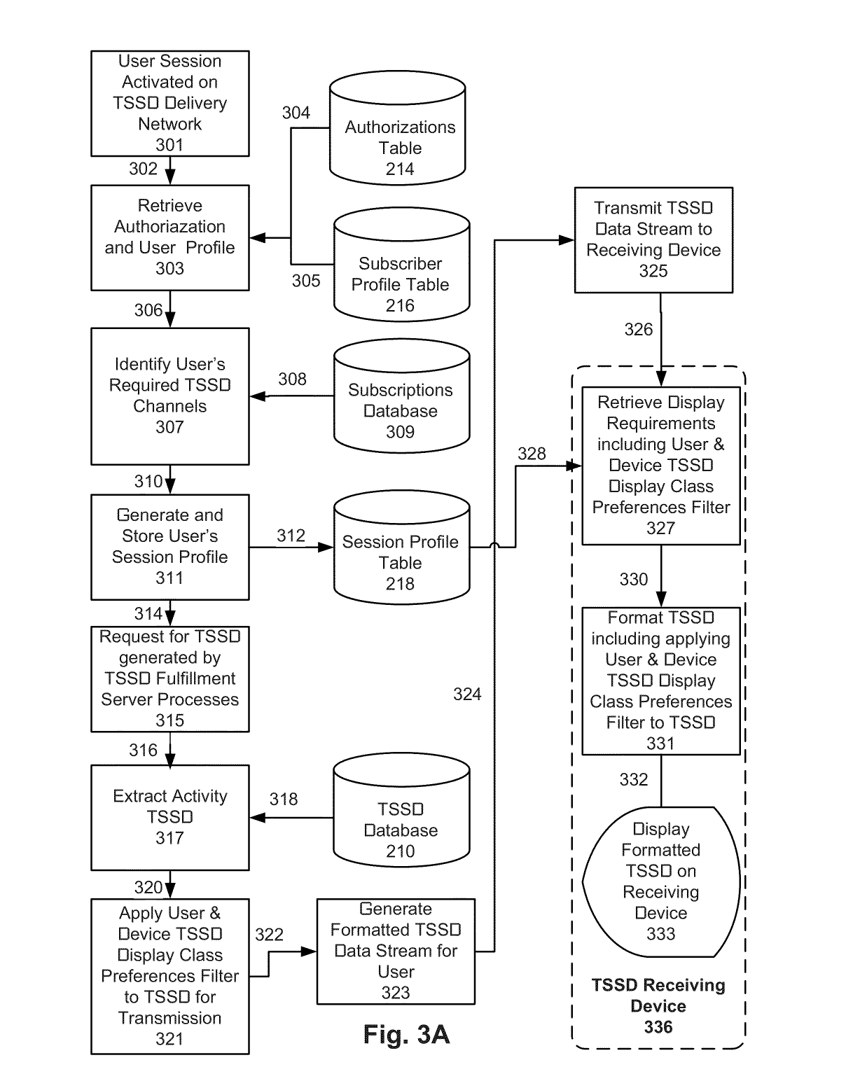

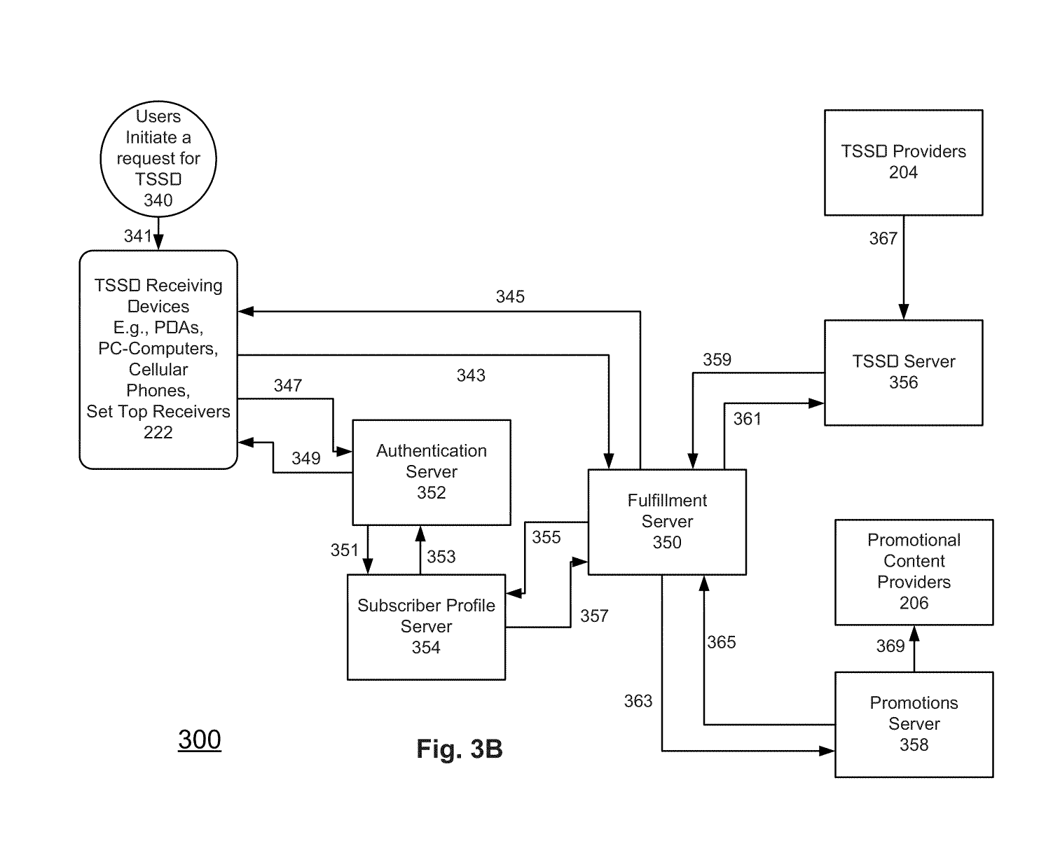

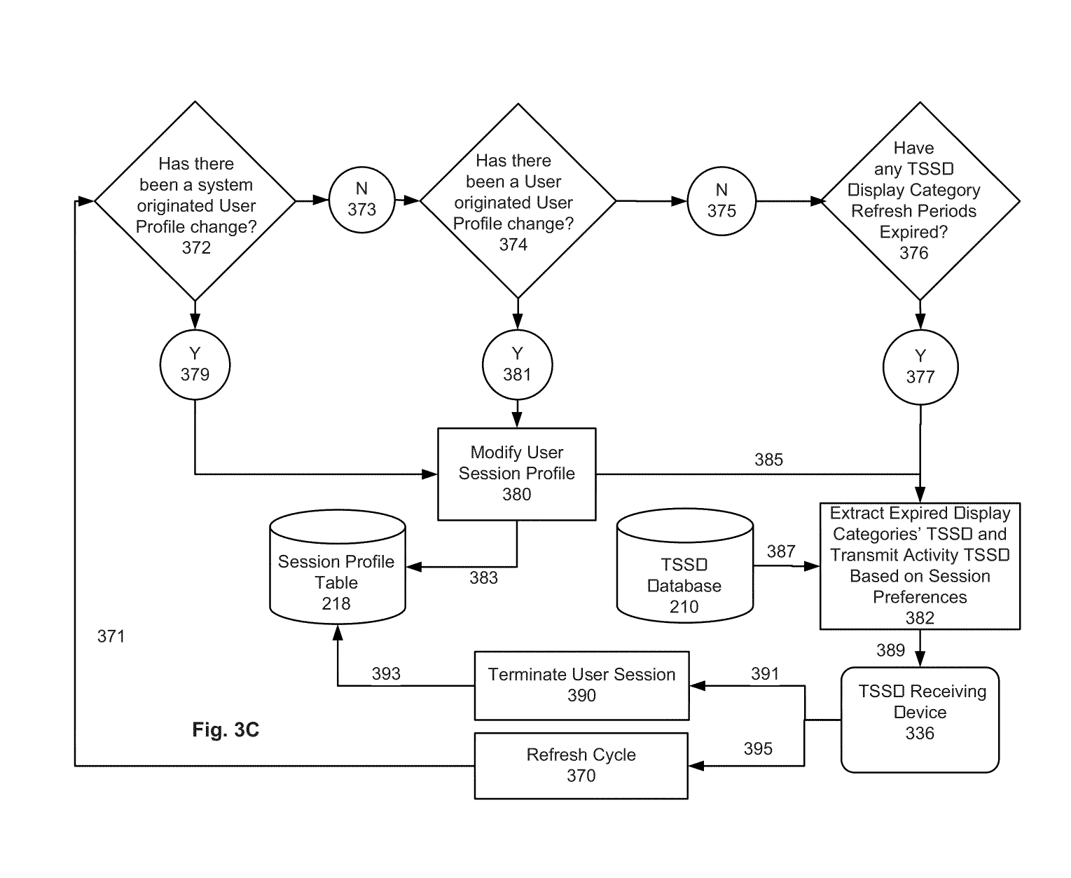

Without grid flow management, the TSSD delivery network may bog down from the excessive transmittal of TSSD, which is neither desired by nor desirable to TSSD consuming group entities 226. In addition, users may find the services unsatisfactory or rendered useless when excessive volumes of TSSD are received. Unnecessary utilization of communications bandwidths may also have undesirable economic consequences. FIGS. 3A, 3B and 3C provide an overview of the processes and components involved in TSSD grid flow management. TSSD grid flow management may extend from activating User Sessions to displaying TSSD on TSSD Receiving Devices 104 and may include refreshing the TSSD content displayed on TSSD receiving devices.

FIG. 3A is a flowchart of the time sensitive scheduling data fulfillment process showing the location of the TSSD display class preference filter functions, and is a representation of the time sensitive scheduling data grid flow management method according to one embodiment of the invention. The process begins with a user session being activated on the TSSD delivery network at block 301. User and receiving device identification may be transmitted via line 302 to a function 303 which can retrieve the user's authorization profile from the Authorization Table 214 and user's subscriber profile from the Subscriber Profile Table 216.

The user and receiving device identification data plus user authorization and subscriber profile data may be transmitted via line 306 to the Identify User's Required TSSD Channels 307. The Identify User's Required TSSD Channels Function 307 may extract the user's active and authorized TSSD channel subscriptions' identifiers from the Subscriptions Database 309 (which it receives via line 308) and may transmit via line 310 user and receiving device identification, user authorization and subscriber profile data and identifiers for the user's authorized and active TSSD channel subscriptions to the Generate and Store User's Session Profile Function 311. The information may be used to generate a user session which contains all the data needed to stream the appropriate, timely and requested TSSD to a user's TSSD receiving device. The Generate and Store User's Session Profile Function 311 may store in the Session Profile Table 218 via line 312, a user session profile which may include the user and receiving device identifiers, the user's TSSD display class preference requests and preferences, the user's assignments of TSSD channels to TSSD Display Class, and administrative parameters such a session profile identifier, starting time, and network use limitations to the Session Profile Table 218.

Once the session profile has been successfully stored, the Generate and Store User's Session Profile Function 311 may trigger a status via line 314 which causes a request for TSSD to be generated by the TSSD Fulfillment Server Processes 315. The request generated by these processes may include data range, time frame, selection TSSD category, and user TSSD subscriptions. The Request for TSSD to be Generated by the TSSD Fulfillment Server Processes 315 may transmit a request via line 316 to the Extract Activity TSSD Function 317 for relevant TSSD to be delivered to the user's receiving device, the user and receiving device identification data, the user's TSSD display category zone preferences, the user's TSSD channel subscriptions, and administrative parameters such a session profile identifier, starting time, and network use limitations. The Extract Activity TSSD Function 317 may extract the targeted TSSD, if any, via line 318 from the TSSD Database 210 and may transmit via line 320 the TSSD along with the user and receiving device identification data and the user's TSSD display class preferences.

The Apply User & Device TSSD Display Class Preferences Filter to TSSD for Transmission Function 321 may receive this transmission and may filter the activity TSSD for transmission as required by the user's TSSD display class preferences and the TSSD receiving devices display class profile. The flow of TSSD to the TSSD Delivery Network grid may be thus restricted to only that TSSD which is relevant and desired for the particular user session and TSSD receiving device. The Apply User & Device TSSD Display Class Preferences Filter to TSSD for Transmission Function 321 may then transmit the results via line 322 to the Generate Formatted TSSD Data Stream for User Function 323 where all of the extracted and formatted TSSD plus identifications information may be consolidated into a TSSD data stream targeted at the user's receiving device.

Continuing to refer to FIG. 3A, the Generate Formatted TSSD Data Stream for User Function 323 may transmit via line 324 the TSSD data stream to the Transmit TSSD Data Stream to Receiving Device Function 325. The Transmit TSSD Data Stream to Receiving Device Function 325 may transmit the TSSD data stream via line 326 through the Communications Cloud to a set of display processes which reside on the user TSSD Receiving Device 336. The Retrieve Display Requirements including User & Device TSSD Display Class Preferences Filter Function 327 may receive the TSSD data stream, and if there is unfiltered activity TSSD or additional TSSD receiving device TSSD display class requirements, the function may extract via line 328 from the Session Profile Table 218, User & Device TSSD Display Class Preferences requirements for the activity TSSD. The Retrieve Display Requirements including User & Device TSSD Display Class Preferences Filter Function 327 may transmit via line 330 to the Format TSSD including applying User & Device TSSD Display Class Preferences Filter to TSSD Function 331, the TSSD data stream and User & Device TSSD Display Class Preferences requirements, if any. In one embodiment, the Format TSSD including applying User & Device TSSD Display Class Preferences Requirements to TSSD Function 331 may parse the TSSD data stream, may filter out TSSD which does not conform to the current sessions TSSD display class preference requirements, may format each TSSD activity as required, and may transmit the results via line 332 to the receiving devices display function. The Display Formatted TSSD on Receiving Device Function 333 may then display the requested activity TSSD on the receiving devices display unit for the user's consumption.

In an embodiment of the invention where the TSSD receiving component of the TSSD Receiving Device 336 may not be physically connected to the display component, but instead may be connected via a communications network, the Format TSSD including applying User & Device TSSD Display Class Preferences Requirements to TSSD Function 331 may provide a secondary TSSD flow grid management facility. An example of this embodiment may be when a single computer is used to drive many displayed devices located throughout a facility such as a convention center or airport. Another example may be when a single computer is used as the primary TSSD receiving device, the TSSD received may be relayed to many other receiving devices within a private network, thereby further reducing the network load of having many TSSD receiving device communicate directly with the TSSD Data Center 100.

FIG. 3B is a flowchart of the time sensitive scheduling data fulfillment process showing the basic components involved in the grid flow management method according to one embodiment of the invention. When a user (an entity) initiates a request for TSSD 340 via a TSSD Receiving Device 104 via line 343 to the Fulfillment Server 350, that request must be accompanied by specific authorizations to use the TSSD Delivery Network, by a session profile identifier, and user and device identifiers. The authorizations and identifiers may be obtained by the TSSD Receiving Device 222 by transmitting a request for authorization via line 347 to the Authentication Server 352. The user and/or the TSSD Receiving Device 222 may be authorized to use the TSSD Delivery Network, the Authentication Server 352 may request via line 351, the entity's subscriber profile from the Subscriber Profile Server 354. The Subscriber Profile Server 354 may return the entity's subscriber profile identifier via line 353 to the Authentication Server 352. The Authentication Server 352 may transmit via line 349, the subscriber profile identifier, the entity's TSSD display class preferences, and administrative parameters such a session profile identifier, starting time, and network use limitations.

When the Fulfillment Server 350 has received all of the required identifiers and authorization to use the TSSD Delivery Network, the Fulfillment Server 350 may initiate a fulfillment process and may request the entity's TSSD channel subscriptions identifiers via line 355 from the Subscriber Profile Server 354. The entity's activity subscription channels' identifiers may be returned via line 357 to the Fulfillment Server 350. The Fulfillment processes on the Fulfillment Server 350 1) may create or update the user's session profile, 2) may create specific TSSD fulfillment requests based on the entity's TSSD subscription channels, TSSD display class preferences (both user and device), the current time, and the requested time frame, 3) may transmit TSSD fulfillment requests via line 361 to TSSD Server 356, 4) may receive TSSD from the fulfillment requests via line 359, 5) may transmit via line 363 TSSD matching parameters to the Promotions Server 358, 6) may receive promotional content via line 365, 7) may format all requested TSSD and promotional content, and 8) may transmit TSSD data streams via line 345 to the TSSD Receiving Device 222.

The Fulfillment Server's 350 fulfillment process may provide the mechanism by which TSSD grid flow management is achieved. By applying the requesting entity's and TSSD receiving device's TSSD Display Class preferences as a filter to TSSD resulting from all of the entity's TSSD channel subscriptions prior to transmitting the TSSD data streams to the TSSD receiving device, the volume of transmitted TSSD may be kept to a minimum with all of the accompanying benefits of the reduced volume.

The TSSD Receiving Device may receive the requested TSSD via line 345 from the Fulfillment Server 350 and may display the formatted TSD for the consuming entity(ies). If the entity desires to adjust the TSSD flow by adding or eliminating TSSD Display Classes displayed during the user session, the request may be transmitted via line 343 to the Fulfillment Server 350 where a user session profile update processes makes the necessary modifications to the entity's user session profile. If the entity desires to adjust the TSSD flow for future user sessions, the adjustment request may be transmitted via line 347 to the Authentication Server 352 and via line 343 to the Fulfillment Server 350. The Authentication Server 352 authorization process function may update the TSSD display class preferences in authorization record for the entity.

The TSSD Server 356 may receive TSSD from TSSD Providers 204 via line 367. The TSSD Server 356 manages the receipt, maintenance and storage of TSSD as necessary. The TSSD Server 356 may supply TSSD based on requests received via line 361 from the Fulfillment Server 350 and may supply the requested TSSD via line 359 to the Fulfillment Server 350.

The Promotions Server 358 may receive TSSD from Promotional Content Providers 206 via line 369. The Promotions Server 358 manages the receipt, maintenance and storage of Promotion Content as necessary. The Promotions Server 358 may supply promotional content based on requests received via line 363 from the Fulfillment Server 350 and may supply the requested TSSD via line 365 to the Fulfillment Server 350.

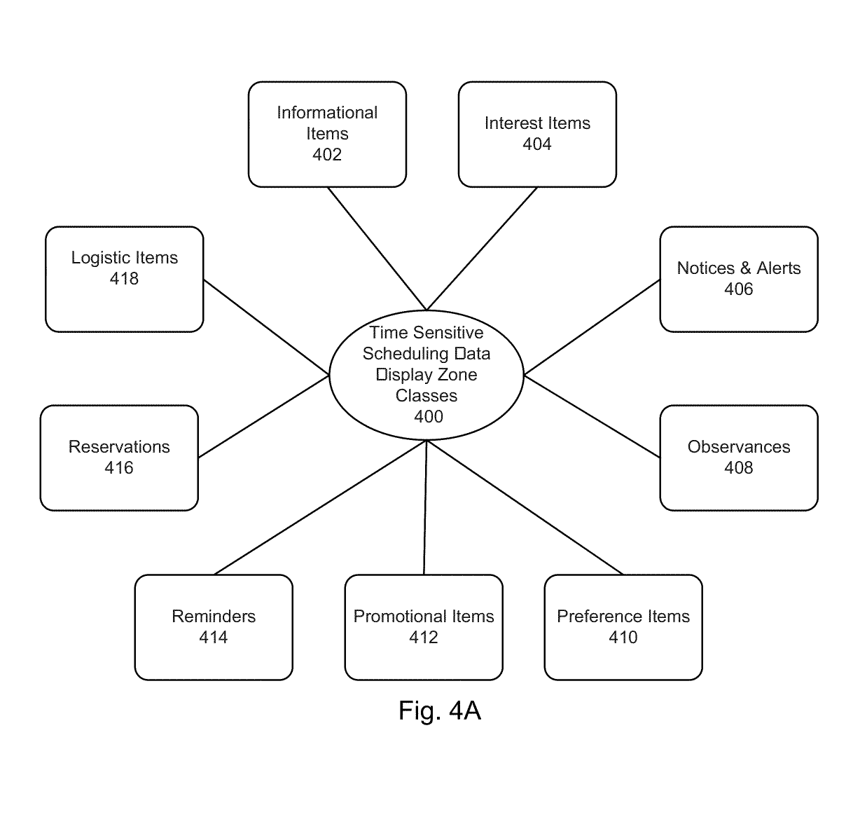

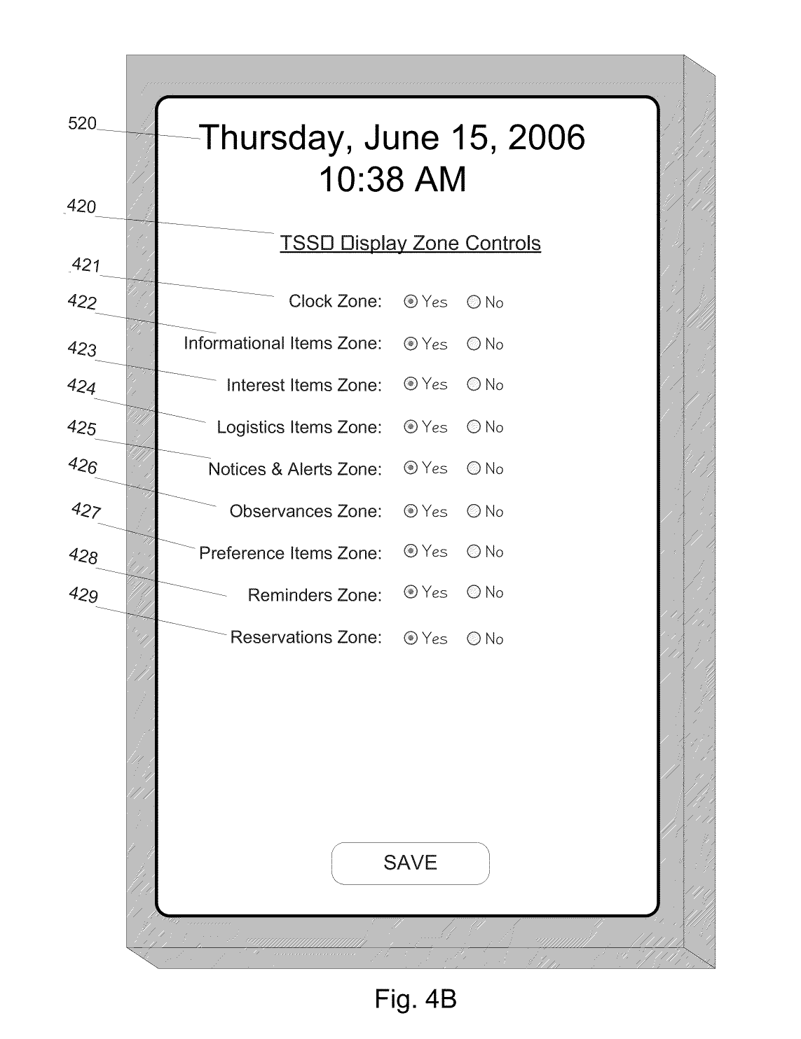

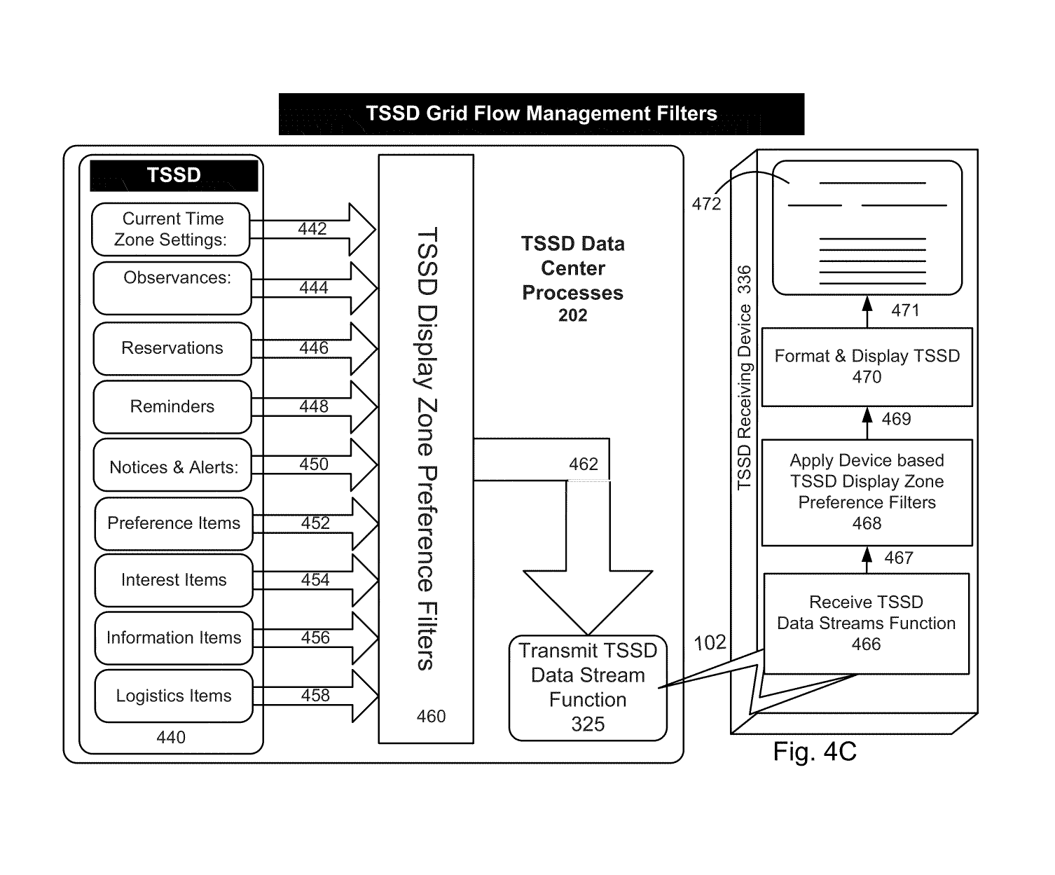

FIG. 3C shows a flowchart of time sensitive scheduling data grid flow management refresh display data process according in one embodiment of the invention. As the TSSD delivery network is primarily a passive communications system, the entity consuming the TSSD may not actively interact with the TSSD delivery controls especially with simple TSSD receiving devices. Thus, the consuming entity's profile is the primary source on control and administrative data. This information is gathered at the start of a user session; the user session profile is set and is not updated unless there is an indication of change. In contrast, however, TSSD and the TSSD delivery network are dynamic. New TSSD items may be added to any channel at any time. As TSSD data streams are aggregations of data from various subscribed to sources, any display of requested TSSD needs to be refreshed periodically to avoid the information being obsolete, expired and/or inadequate. The TSSD grid management method may include parameters to establish how often specific classes of TSSD Display Zones 400 in FIG. 4A should be refreshed and under what other condition the refresh process should occur. As may be appreciated, refreshing too frequently may unnecessarily burden the TSSD delivery network by increasing the volume of TSSD flowing through the network.

Referencing FIG. 3C, the time sensitive scheduling data grid flow management refresh display data process may be a cyclical procedure that begins and ends with processing running on an activated TSSD Receiving Device 336. After displaying requested TSSD by the Display Formatted TSSD on Receiving Device Function 333 (FIG. 3A), the TSSD Receiving Device 336 either may initiate via line 395 a Refresh Cycle 370, or may initiate via line 391 at the user's request or device time-out state, a Terminate User Session Function 390.

When a Refresh Cycle 370 begins, the time sensitive scheduling data grid flow management refresh display data process may perform a set of ordered status checks. Via line 371, the process may determine if there has been a system originated User Profile change 372 such as a channel subscription or the user's network access authorization has expired. If yes 379, then the Modify User Session Profile Function 380 may be initiated. If no 373, the process may determine if there has been a User originated User Profile change 374 such as a request to add or eliminate a channel subscription or to turn on or off a TSSD display zone. If yes 381, then the Modify User Session Profile Function 380 may be initiated. If no 375, the process may determine if Have any TSSD Display Category Refresh Periods Expired 376. In certain embodiments, a no condition may relate to no action taken. If yes 377, the process may initiate a fulfillment request to the Extract Expired Display Categories' TSSD and Transmit Activity TSSD Based on Session Preferences Function 382. This function may extract the specified TSSD via line 387 from the TSSD Database 210, and may transmit the update TSSD data stream via line 389 to the TSSD Receiving Device 336. If the Modify User Session Profile Function 380 is initiated by changes in the user's profile at 379 or 381, then the function via line 383 may update the user session profile in the Session Profile Table 218 and via line 385 may initiate a fulfillment request to the Extract Expired Display Categories' TSSD and Transmit Activity TSSD Based on Session Preferences Function 382. The final stage of the time sensitive scheduling data grid flow management refresh display data process may occur when the TSSD Receiving Device 336 may initiate via line 391 at the user's request or device time-out state, the Terminate User Session Function 390. This function may update the user session profile via line 393 in the Session Profile Table 218 setting the session status to “terminated.” The TSSD Receiving Device 336 may exit its TSSD delivery network access or may remain in a state were the TSSD display zones are not updated.

FIG. 4A presents the TSSD Display Zone Classes 400 in an embodiment of the invention. The primary TSSD Display Zone Classes 400 may be Informational Items 402, Interest Items 404, Notices & Alerts 406, Observations 408, Preference Items 410, Promotional Items 412, Reminders 414, Reservations 416 and Logistics Items 418. In one embodiment, a primary TSSD Display Zone may be subdivided into sub-zones.

In an embodiment of the invention, items which may be displayed in the Observances TSSD display zone class 408 may include religious and secular holidays, government established days of recognition (a heroic figure's birthday), observance (Memorial Day) or activity (tax day), and life events (such as birthdays, anniversaries, personal commemorations, rites of passage, and beginning and ending of activity seasons, school years and work periods).

In an embodiment of the invention, items which may be displayed in the Reservation TSSD display zone class 416 may include notices of upcoming ad hoc events such a restaurant reservation, a golf tee time, or a medical appointment.

In an embodiment of the invention, items which may be displayed in the Notices & Alerts display zone class 406 may include upcoming public safety or health activities of local and regional government agencies or emergency service organizations, upcoming TSSD delivery network system service activities, and previously occurring logistical events.

In an embodiment of the invention, items which may be displayed in the Logistics Items display zone class 418 may include activities and milestones occurrences related to the ultimate delivery of material or services.

In an embodiment of the invention, TSSD items representing meetings, events and activities of organizations from TSSD channels which a user has subscribed to or been assigned based on affiliation, may be included in the Preference Items display zone class 410, the Informational Items display zone class 402, or the Interest Items display zone class 404 may be based on the user's designation for the specific TSSD channel. Individual TSSD items may be transformed into reminders by user designation, and thereby may be included in the Reminders display zone class 414.

In an embodiment of the invention, items which may be displayed in the Reminders display zone class 414 items may include user designated notices of upcoming TSSD items such as an event, meeting or ad hoc activity.

In another embodiment of the invention, TSSD items may appear in Preference Items display zone class 410, the Informational Items display zone class 402, or the Interest Items display zone class 404 based on the predefined purpose or role for the TSSD receiving device.

FIG. 4B shows the time sensitive scheduling data display zone control switches on a sample display screen according to one embodiment of the invention. The TSSD display zone controls may be the primary user managed controls in the TSSD grid flow management method. Under the heading TSSD Display Zones Controls 420, is listed a binary control switch for TSSD Display Zone Classes (e.g., TSSD Display Zone Classes 400) identified in FIG. 4A. It may be appreciated that a control switch may not be provided for Promotional Items Display Zone 412 which is not under user control. The switch may be either on as indicated by a selected Yes radio button or off as indicated by a selected No radio button. When a TSSD display zone control switch is on, that category of TSSD may flow through the TSSD delivery network grid to a TSSD Receiving Device 336. The set of switches may include the Informational Items Zone 422, the Interest Items Zone 423, the Logistics Items Zone 424, the Notices & Alerts Zone 425, the Observances Zone 426, the Preference Items Zone 427, the Reminders Zone 428, and Reservations Zone 429. Although not shown in FIG. 4B, TSSD display zone controls may be enhanced to reflect TSSD display zone class subclasses and other categories according to one embodiment of the invention.

Also there may be a switch for the Clock Display Zone 421 which may not be a time sensitive scheduling data display zone class, but may allow the user to determine whether the reception zone date and time are displayed on TSSD Receiving Devices 104 by the TSSD delivery network process. In certain embodiments, such as cell phones or digit clocks, the date and time display may be built into the device in such a way that the user can not turn it off. In these devices, it may be redundant for the TSSD delivery network method to display the reception zone date and time. In these cases, the Clock Display Zone 421 switch provides a mechanism to remove the redundant display of that information.

FIG. 4C shows the locations of where time sensitive scheduling data display zone preference filtering is applied within the grid flow management process according to one embodiment of the invention. The TSSD Data Center Processes 202 may include fulfillment methods that produce TSSD display zone data streams 442 through 458 from the TSSD data store 440. At the first set of filters, the TSSD Display Zone Preference Filters 460 may act as gateways either permitting that display class of TSSD to flow or blocking that display class of TSSD from becoming part of the aggregated TSSD Data Stream 462. The aggregated TSSD data stream 462 may be transmitted by the Transmit TSSD Data Stream Function 325 across the TSSD Delivery Network via connectivity medium 102 to TSSD Receiving Device 336. The aggregated TSSD data stream may be received by the Receive TSSD Data Stream Function 466. The TSSD Receiving Device 336 may include the capability to Apply Device based TSSD Display Zone Preference Filters 468 as a second set of filters. This capability can accommodate users to temporarily adjust TSSD display zones shown on their receiving device without modifying their session and user profiles, and without requesting a retransmission of TSSD data streams adjusted for temporary preferences changes. The TSSD data stream received at the TSSD Receiving Device 336 is forwarded to the Format & Display TSSD Function 470 directly from the Receive TSSD Data Streams Function 466 or, when filtering capability is present, after having device based TSSD display zone preferences applied to the data stream. The Format & Display TSSD Function 470 makes any final display adjustments necessary for the TSSD receiving device (e.g., stripping off TSSD end times and activity descriptions to maximize items displayed on small screens), and then displays the resulting TSSD on the display screen 472.

FIGS. 5A-5M illustrate an operation according to one or more embodiments of the present invention. Referring first to FIG. 5A, a schematic representation is provided according to one embodiment. Referring now to FIG. 5B, a representation of a display of a planning “day list” view of time sensitive scheduling data is shown which demonstrates the presentation of event, meeting and other activity items as they may appear in many calendaring or scheduling applications according to one or more embodiments of the invention. In contrast, FIG. 5C presents a schematic of TSSD display zones in a format similar to FIG. 5A on a TSSD receiving device display screen in one embodiment of the invention. FIGS. 5D-5h present representations of display screens for various TSSD receiving devices demonstrating both alternative page views and the effects of using zone controls to manage the flow of TSSD through the delivery network according to one or more aspects of the invention. For ease of comparison and to facilitate the illustration of major points, all figures are presented in the same time frame and from the same pool of TSSD activity data. The differences reflected may be from simulated grid flow management by the user and/or receiving device profile preferences. The element identification numbers on the figures which are sample data and view examples correspond to the element identification numbers on the schematic diagrams.

FIG. 5A shows a schematic of a day display screen 500 and its component areas as may be presented in many digital and paper calendar products today. FIG. 5B shows example data in the corresponding component areas. There maybe a date area 501, a local time display 502 (on digital products), and an observances area 514 for holidays and recognitions, a page title area 513, a time frame scale 511, and various activity items 506-510. These activity items may be displayed in a manner which includes local starting and ending times and/or along the time scale in a manner which indicates starting and ending times. Although not relevant to these display systems or how these items are presented on the display, these activity items may be from several type classes of TSSD such as preference items 506 and 508, reservation item 507, information item 509 and reminder item 510. In some of these applications, individual activity items may be assigned a display priority which determines whether it is displayed or stacked on top of other activity items when display space limitations prevent activities with simultaneous or overlapping time frames from fully appearing in the display space allotted.

FIG. 5C presents a schematic of display zones on a TSSD receiving device display according to another embodiment of the invention. There may be one or more of the following TSSD type display zones: Observances 521, Reservations 522, Reminders 523, Notices & Alerts 524, Preference Items 525, Informational Items 526, Interest Items 527 and Logistics Items 528. Also, there may be a Clock display zone 520 which contains the current or target date and the current or target time. In addition, there may be a Display Control and Administration Buttons Zone 529 which contains controls to enable or disable display zones.

Observances 521, Reservations 522 and Notices & Alerts 524 TSSD type display zones may contain homogeneous TSSD items in their display zone. Holidays, birthdays, and anniversaries are displayed in Observances display zone 521. Reservations such as restaurant reservations, a golf tee time, or medical appointments are displayed in the Reservations display zone 522. Logistics activities such as placement of cargo on a transport, arrival of cargo at a port or depot, arrival of relative at the airport or completion of a prescription order at the pharmacy are displayed in the Logistics Items display zone 528. System notices, emergency broadcast alerts, and community alerts are displayed in the Notices & Alerts display zone 524. The remaining TSSD type display zones may be generic. An organization's meetings and events may be displayed in the Preference Items display zone 525, the Informational Items display zone 526, or the Interest Items display zone 527 according to the preferences, affiliations and profiled areas of interest of a specific user or associated with a specific TSSD receiving device.

In an embodiment of the invention, by controlling which display zones appear on a TSSD receiving device display, a user may control which TSSD channels and which types of TSSD flow through the distribution grid of the TSSD Delivery Network for the user.

In another embodiment of the invention, a TSSD receiving device may be established for a dedicated purpose of designating only specific channels which may be received and only specific TSSD display zones which may be enabled for the device. For example, a “conference center bulletin board system” may be created by attaching a TSSD receiving device with a profile set to receive only the TSSD channels on which conference center activities are disseminated, to treat the TSSD received as TSSD preference items and display those TSSD items in the preference display zone 525. Then this TSSD receiving device may be attached to display screens though out the facility creating a “conference center bulletin board system.” The conference center bulletin board system may be further expanded with dedicated portable TSSD receiving devices distributed to attendees or with other TSSD receiving devices that assume a profile identical to the dedicated purpose receiving devices.

FIG. 5D presents an embodiment of the invention where a laptop or desktop computer and its display screen may be used as a personal TSSD receiving device according to another embodiment of the invention. In this embodiment, the following TSSD display zones may be enabled: the Clock display zone 520, the Observances display zone 521, the Reservations display zone 522, the Reminders display zone 523, the Notices & Alerts display zone 524, the Preference Items display zone 525, the Informational Items display zone 526, the Interest Items display zone 527 and the Display Control and Administration Buttons Zone 529.

FIG. 5E presents another embodiment of the invention where a cell phone and its display screen may be used as a personal TSSD receiving device according to another embodiment of the invention. In this embodiment, the following TSSD display zones may be enabled: the Observances display zone 521, the Reservations display zone 522, the Reminders display zone 523, the Notices & Alerts display zone 524, the Preference Items display zone 525, the Interest Items display zone 527 and the Display Control and Administration Buttons Zone 529. The Informational Items display 526 may be turned off such that nothing appears in the Notices & Alerts display zone as there may not be a relevant Notice & Alert TSSD for this entity (user). This embodiment utilizes the functionality of the cell phone's own time and date display 530 to provide the viewer a current time reference; therefore, the Clock display zone 520 can be turned off. This embodiment of the invention and the examples FIG. 5F-5M demonstrates the flexibility of the TSSD grid management mechanism in adjusting the TSSD flow to the target TSSD receiving device. Priority can be assigned and given to displaying specific classes of TSSD displays zones and the TSSD received therein, thus minimizing problems from which could result from the passive receiving of voluminous data.

FIG. 5F presents an embodiment of the invention where a digital clock may be transformed into TSSD receiving device thereby becoming an intelligent or smart clock according to another embodiment of the invention. This may be an example of creating a new class of product based on extending its functionality. The TSSD smart clock can retain the digital clock's time and date display 530, but adds a display window 550 which vertically scrolls display frames. FIG. 5F shows the first TSSD window frame and FIG. 5G presents TSSD window frames 1-6 in a series of six TSSD window frame snapshots. Each TSSD window frame displays specific TSSD display zones for about two minutes in this example. The digital clock performs its historical function of displaying the current date and time, and the TSSD display clock zone is turned off in the device profile preferences. In FIG. 5F and FIG. 5G frame 1, the TSSD window frame displays TSSD and zone headings for the Observances Zone 521 and Reservations Zone 522. In FIG. 5G frame 2, the TSSD window frame displays TSSD and zone headings for the Reminders Zone 523 and Notices & Alerts Zone 524. In FIG. 5G frame 3, the TSSD window frame displays TSSD and zone headings for the Preference Items Zone 525. In FIG. 5G frame 4, the TSSD window frame displays addition Preference Items TSSD and zone headings for the Preference Items Zone 525. In FIG. 5G frame 5, the TSSD window frame displays no TSSD (there is none available meeting the requested profile and preferences), but displays zone headings for the Informational Zone 526. In FIG. 5G frame 6, the TSSD window frame displays TSSD and zone headings for the Interest Items Zone 527. The process can repeat as long as the smart clock remains powered up and is connected to the TSSD delivery network.

FIG. 5H presents an embodiment of the invention where a digital picture frame may be transformed into TSSD receiving device thereby becoming an intelligent or smart display device. This may be one example of the invention creating a new class of product based repurposing or enhanced functionality. The TSSD smart digital picture can retain its ability to display digitally stored images on its display screen 560, but adds the ability to insert TSSD window frames as it rotates display frames. FIG. 5H shows the first TSSD window frame and FIG. 5I presents TSSD window frames 1-6 in a series of six TSSD window frame snapshots. Each TSSD window frame displays specific TSSD display zones for about two minutes in this example. The digital picture frame utilizes the Clock display zone 520 to display the current date and time in the reception time zone. In FIG. 5H and FIG. 5I frame 1, the TSSD window frame displays TSSD and zone headings for the Observances Zone 521, the Reservations Zone 522, the Reminders Zone 523 and Notices & Alerts Zone 524. In FIG. 5I frame 2, the TSSD window frame displays a stored image. In FIG. 5I frame 3, the TSSD window frame displays TSSD and zone headings for the Preference Items Zone 525. In FIG. 5I frame 4, the TSSD window frame displays a stored image. In FIG. 5I frame 5, the TSSD window frame displays the zone headings for the Informational Zone 526 and the Interest Items Zone 527 along with Interest Item TSSD. In FIG. 5I frame 6, the TSSD window frame displays the TSSD window frame displays a stored image. The process can repeat as long as the smart picture frame remains powered up and connected to the TSSD delivery network.

FIG. 5J and FIG. 5K present an embodiment of the invention where a set top receiver such as a cable TV or satellite TV receiver may be transformed into TSSD receiving device with enhanced functionality. This is an example of an embodiment of the invention that creates a new class of product based on altering the devices behavior. When TV programming is being watched, the TSSD may be displayed as a scrolling marquee 540 of the TSSD data stream 542 as shown in FIG. 5J; and when the television programming is not being watched, the receiver may be set to display TSSD data streams as presented in FIG. 5K. As with the previous examples, TSSD and headings from the Observances Zone 521, Reminders Zone 522, Notice & Alerts Zone 524, Preference Items Zone 525, Informational Items Zone 526 and Interest Items Zone 527 are shown in non-TV program view mode FIG. 5K, however, only priority items such Observances, Reminders, Reservations and Preference Items are shown in the TV viewing mode FIG. 5J.

FIG. 5L and FIG. 5M present an embodiment of the invention where a wireless router may be transformed into TSSD receiving device with dual purpose functionality. This is an example of the invention creating a new class of product based on adding a second major purpose or utility for the device without modifying the original purpose or utility of the device. In this embodiment of the invention, the invention may leverage the wireless router's capability to remain connected to the TSSD delivery network via the internet. Then by adding a display screen, a TSSD receiving component and esthetic framing for the product, a new product emerges with greater utility to the owner. FIG. 5L shows a front view of such a device. In the example presented the device's TSSD device profile preferences enable the requesting and displaying of the Observances Zone 521, the Reservations Zone 522, the Reminders Zone 523, the Preference Items Zone 525, and the Interest Items Zone 527. In addition, for added functionality the Clock Zone 520 is turned on. FIG. 5M presents a back view of this embodiment of the invention showing router electronic and antenna components are concealed behind front framing.

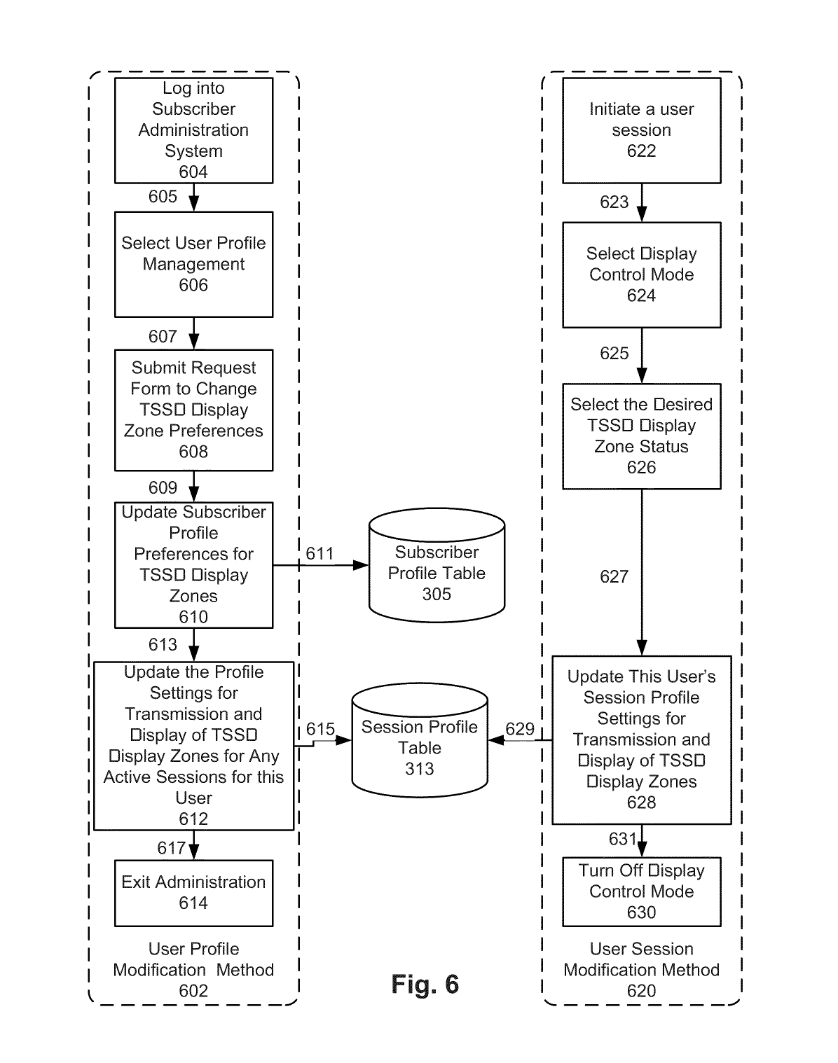

FIG. 6 is a flowchart showing two methods a user may use to specify a desired level of TSSD flow according to one embodiment of the invention. The User Profile Modification Method 602 may allow the user to set the TSSD display class preferences that remains in effect until the setting is modified by the user, i.e., the TSSD display class preferences for all future session until changed by the user. The User Session Modification Method 620 may allow the user to set a TSSD display class preference which effects only this user session and remains in effect until the current user session ends, until the user makes another session modification or until the Privacy Protection Mode Setting is modified by the User Profile Modification Method 602.

Using the User Profile Modification Method 602 to set the TSSD display class preferences, the user logs into the Subscriber Administration System 604. Next, the user, via path 605, may select the User Profile Management Function 606. Within this function, the user, via line 607, may then submit a Request Form to Change TSSD Display Zone Preferences 608. The TSSD display zone preference selections may then be transmitted via line 609 to the Update Subscriber Profile Preferences for TSSD Display Zones 610. The Update Subscriber Profile Preferences for TSSD Display Zones Function 610 may update the user's subscriber profile in the Subscriber Profile Table 305 via line 611, and may forward the TSSD display zone preferences via line 613 to a function which updates any active session profiles for this user. The Update the Profile Settings for Transmission and Display of TSSD Display Zones for Any Active Sessions for this User 612 may update active session profiles via line 615 in Session Profile Table 313. The user may end this method by Exiting the Administrative Function 614 via line 617.

According to the second method, the user may initiate a User Session at 622 using the User Session Modification Method 620 to set the TSSD display zone preferences for the current user session. Next the user may select to transition to the Display Control Mode Function 624 via line 623 and may select to transition to the Select the Desired TSSD Display Zone Status Function 626 via line 625. The Select the Desired TSSD Display Zone Status Function 626 may present a set of TSSD display zone options to the user and may forward the user's selection via line 627 to a function which updates the user's session profile. The Update This User's Session Profile Settings for Transmission and Display of TSSD Display Zones Function 628 via line 629 may update the user's session profile in the Session Profile Table 313. The user, via line 631, may end this method by Turning off Display Control Mode 630.

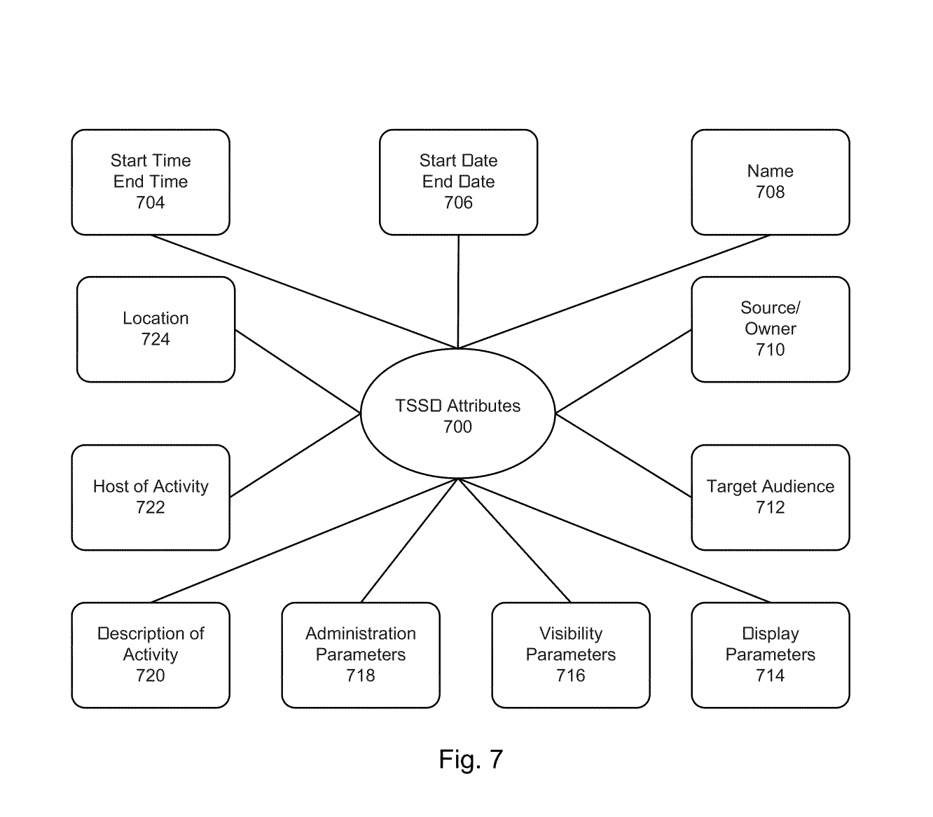

FIG. 7 is an objects diagram illustrating the basic TSSD Attributes 700 according to an embodiment of the invention. In the objects diagram are defined sets of TSSD attributes. These TSSD attributes may include: Start Time/End Time 704; Start Date/End Date 706; Name/Title 708; Source/Owner 710; Target Audience 712; Display Parameters 714 may include graphics, logos, captions, and colors; Visibility Parameters 716 (e.g., posting date, hide flag); Administration Parameters 718 (e.g., who created, when created); Description of Activity 720; Host of Activity 722; and Location 724.

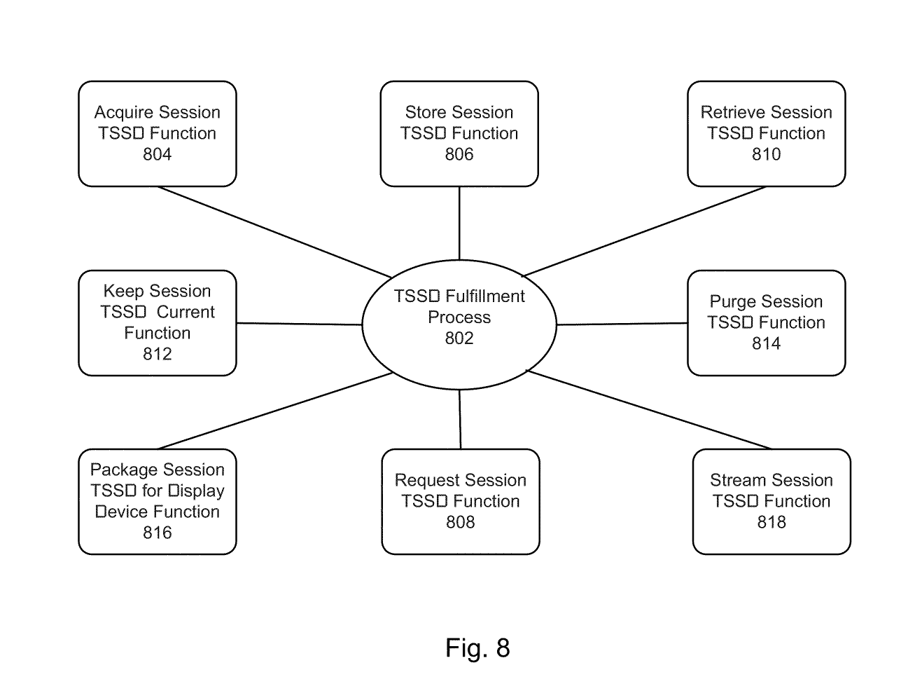

FIG. 8 shows an object diagram displaying the primary activity functions of the TSSD fulfillment process according to one embodiment of the invention. The TSSD Fulfillment Process 802 may be the central activity of the TSSD delivery network and may be coordinated by the fulfillment server 350 described earlier and depicted in FIG. 3B. The primary activities embodied in the TSSD fulfillment process may be acquiring session TSSD 804, storing session TSSD 806, requesting session TSSD 808, retrieving session TSSD 810, keeping session TSSD current 812, purging session TSSD 814, packaging session TSSD for specific display devices on specific TSSD receiving devices 816 and streaming session TSSD 818 to receiving devices. Session TSSD is that TSSD flowing through the TSSD delivery network relevant to a specific user during that user's current network session. The session TSSD data stream may include announcements, schedules, events, meetings, activities of associations and affinity groups, and promotional content.

The TSSD Fulfillment Process 802 may gather all the necessary information and functions to build a TSSD data stream for a user's current session. The acquire session TSSD function 804 may interrogate the user's profiles and preferences then may determine what TSSD should be acquired to create the TSSD data stream for the user's current session. The request session TSSD function 808 may prepare the appropriate network request objects for the retrieve session TSSD function 810 to obtain the TSSD for the user's current session. The retrieve session TSSD function 810 may issue the necessary extraction requests across the TSSD delivery network to obtain the TSSD for the current session. The store session TSSD function 806 may aggregate and store the retrieved TSSD, TSSD extraction requests and user preferences in preparation for transmitting the resulting TSSD data stream to the user. The package session TSSD for display device function 816 may modify the TSSD data to accommodate display functionality requirements on the user's receiving device. The stream session TSSD function 818 may assemble the TSSD stream for the user's current session and may transmit the TSSD data stream. The keep session TSSD current function 812 may modify the TSSD extraction requests and preferences as necessary to maintain the currency of the TSSD data stream during the user's current session. The purge session TSSD function 814 may remove TSSD from the data stream when it expires or no longer meets the preference requirements of the user for the current session.

Various activity data collection mechanisms may enable TSSD Fulfillment Process 802 to create the TSSD data stream for a user session. Activity data collection mechanisms may include various multi-platform, multi-communications TSSD receiving devices or web browsers. These TSSD receiving devices may include simple devices, advanced devices, embedded systems devices, individual access devices (e.g., cellular phones, PDAs), and community access devices (e.g., set tops equipped with input devices, kiosks) or these web browsers may include PDAs, PCs, cellular phones, tablet PCs. Other data collection mechanisms may include call centers that provide direct contact information transfers and bulk purchase of activity data from vendors.

The stream session TSSD function 818 may assemble a data stream containing one or more profiled and prioritized feed packets of content known as a channel. The channel may be now ready to be transmitted to windows in display devices. The display devices may be portable or fixed placement. The portable display devices may include receiving devices, PDAs, cellular phones, personal computers, workstations, and servers. The fixed placement display devices may include public place business display screens, home entertainment appliance displays, business display screens in a public place, business display screens on company property in public areas, and business display screens on company property in private areas and a combination thereof.

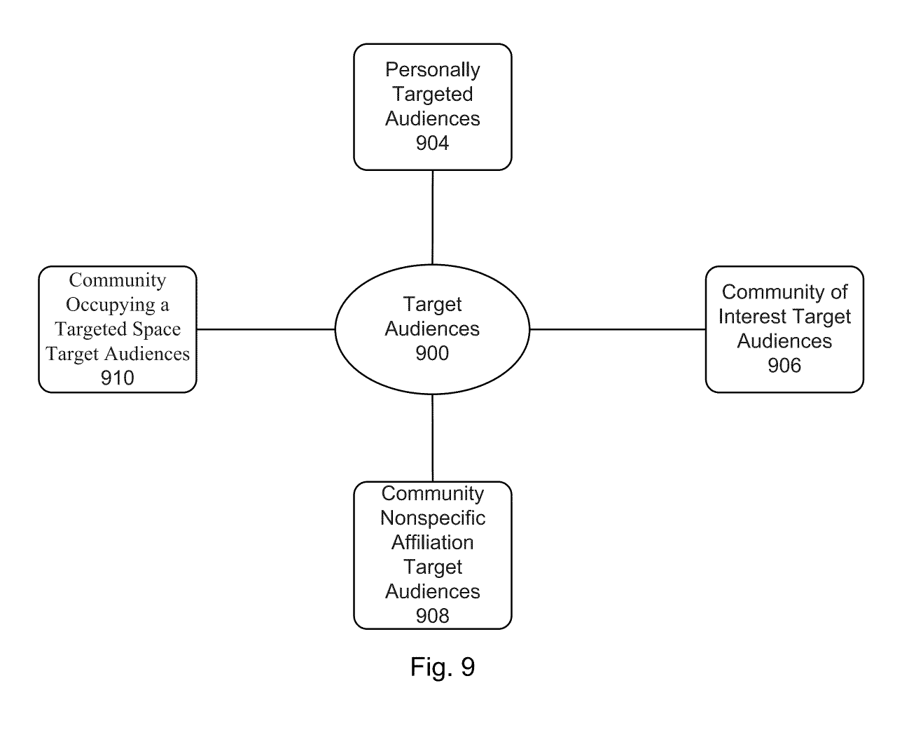

FIG. 9 is a class diagram illustrating classes of target audiences for time sensitive scheduling data according to an embodiment of the invention whose classification may impact device profile preferences for grid flow management. In the class diagram are displayed the primary audience classes of Target Audiences 900.

In one embodiment, Personally Targeted Audiences 904 may be individuals to whom specific TSSD and promotional material are streamed based on the attributes and preferences explicit in their personal profile in the TSSD privacy protection method. Personally Targeted Audiences 904 may include audiences targeted by self-chosen membership or direct affiliation with a TSSD provider. Examples of Personally Targeted Audiences 904 are active members of a service or social club, lapsed members of a trade association, board members of a not-for-profit organization, board members, staff or clients of a business, and individual subscribers to the TSSD delivery network. TSSD receiving devices for this class may have TSSD display class preferences set to display or play Preferred Items, Interest Items, Informational Items, Reminders and Observances.

Community of Interest Target Audiences 906 may correspond to audiences who share identified common affiliations deemed significant for this invention and to whom specific TSSD and promotion materials are streamed based on their affiliations, the common attributes derived for the community group, and the specific preferences of significant members of the community group. Community of Interest Targets 906 may include dentist, alumni of a college, fans of an artist or genre of music, and wine lovers who prefer cabernet sauvignon. TSSD receiving devices for this class may have TSSD display class preferences set to display or play Preferred Items, Interest Items and Observances.

In one embodiment, Community Nonspecific Affiliation Target Audiences 908 may be audiences who share identified common attributes deemed significant for this invention and to whom specific TSSD and promotion materials are streamed based on the common attributes and affiliations derived for the community group, and the specific preferences of significant members of the community group. Community Nonspecific Affiliation Target Audiences 908 may include adults age 26-35 or people who attended a conference on space exploration last year. TSSD receiving devices for this class may have TSSD display class preferences set to display or play Preferred Items and Observances.

Community Occupying a Targeted Space Target Audiences 910 may be audiences who share a common space (physical or virtual) at a targeted time deemed significant for this invention and to whom specific TSSD and promotion materials are streamed based on the occupancy of that space at that time. Community Occupying a Targeted Space Target Audiences 910 sharing a physical space may include sports, concert, performing arts event attendees, attendees of conferences and conventions, attendees at public festivals such as art and wine festivals or food festivals, attendees at political rallies and attendees at private events such as weddings, roasts, church services or observances. Community Occupying a Targeted Space Target Audiences 910 sharing a confined space may also include passengers on a bus, boat, plane or train. Community Occupying a Targeted Space Target Audiences 910 sharing a virtual space may include all internet users browsing a particular organization's website, all phone users participating in a conference call, all attendees to a virtual web conference. TSSD receiving devices for this class may have TSSD display class preferences set to display or play Informational Items, and Observances.

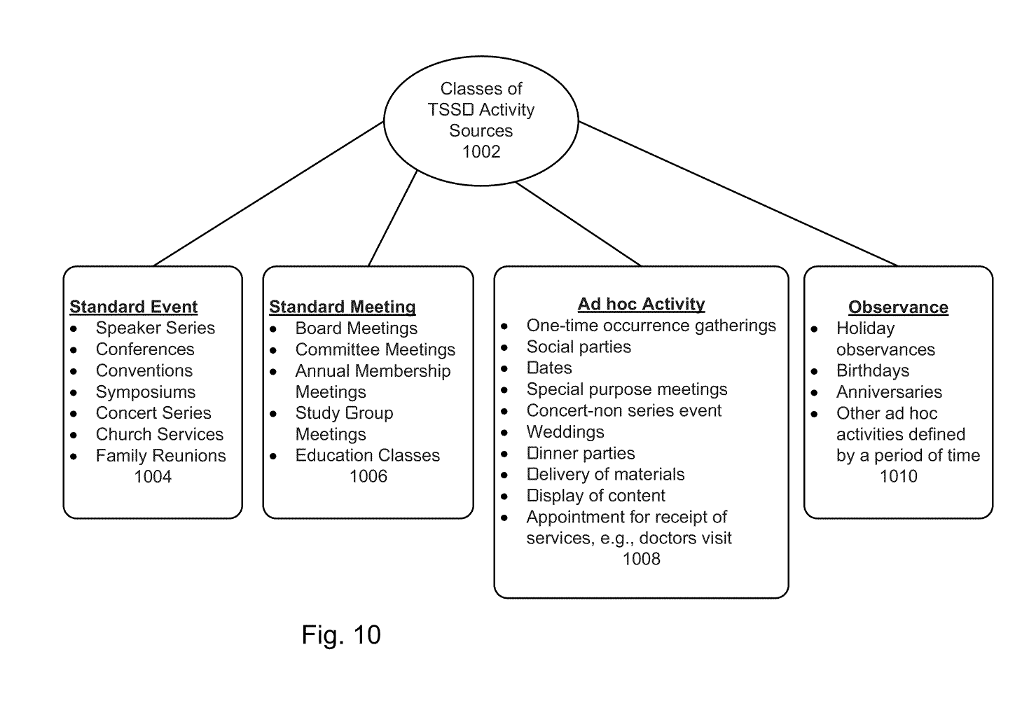

FIG. 10 is a class diagram illustrating classes of TSSD Activity Sources 1002 according to an embodiment of the invention. In the class diagram are described common TSSD activities. These classes for TSSD Activity Sources 1002 include Standard Events 1004, Standard Meetings 1006, Ad Hoc Activities 1008, and Observances 1010. The term gathering as used herein may be considered in a metaphorical context and is not intended to indicate only geographic presence or proximity. For example, in celebrating holidays or life events (e.g., birthdays or wedding anniversaries), a number of people give credence or significance to a period or point in time, but do not necessary gather together in the same geographic space.

Standard Meetings 1006 may be generally recurring gatherings of the same individuals for the purpose of conducting the business of the association. Standard Meetings 1006 may include board meetings, committee meetings, annual membership meeting, study group meeting, delegate conventions, and educational classes.

Standard Events 1004 may be routine and non-routine gatherings of the same or ad hoc groups of individuals in association for purposes other than conducting the regular business of the associations. Standard Events 1004 may include speaker series, educational conferences, symposiums, concert series, church services, and family reunions.

Ad Hoc Activities 1008 may encompass all other pre-announced gatherings of individuals for social purposes. Ad Hoc Activities 1008 may include ad hoc associations, one-time occurrence gatherings, social parties, social dates, special purpose/ad hoc meeting, non-series concerts, weddings, dinner parties and logistical events such as the delivery of materials, displays of some content or an appointment to receive services.

Observances 1010 may include routine recognition of a holiday or special activity date such as Election Day or tax due date and ad hoc life events such as a birth or a marriage. Observances 1010 may be mass recognitions of an ad hoc event or are ad hoc or routine gatherings of the same or ad hoc groups of individuals in association for purposes of commemorating an event or occurrence.

The invention is preferably implemented by software, but can also be implemented in hardware or combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The drawings and the foregoing description gave examples of the present invention providing a mechanism for controlling the flow and receipt of time sensitive scheduling data and related aspects. Although depicted as a number of disparate functional items, those skilled in the art will appreciate that one or more of such elements may well be combined into single functional entities. Alternatively, certain elements may be split into multiple functional elements. The scope of the present invention, however, is by no means limited by these specific examples. Numerous variations, whether explicitly given in the specification or not, such as differences in structure, dimension, and use of material, are possible. Although the present invention has been described in considerable detail with reference to certain embodiments thereof, the invention may be variously embodied without departing from the spirit or scope of the invention. Therefore, the following claims should not be limited to the description of the embodiments contained herein in any way.

What is claimed is:

1. A method for controlling flow of content and receipt of time sensitive scheduling data via a time sensitive scheduling data delivery network, the method comprising:
accommodating, by a host system, management of display of potentially voluminous time sensitive scheduling data, the host system including at least a processor system having one or more processors and a memory system;
making, by the processor system, relevant time sensitive scheduling data information available from high capacity remote data stores accessible to a user's time sensitive scheduling data receiving devices via a time sensitive scheduling data delivery network, and on demand by a time sensitive scheduling data display zone category to the user's time sensitive scheduling data receiving devices; and
managing dynamically, by the host system, which display zone classes and subclasses of time sensitive scheduling data appear, which time frames appear and how much time sensitive scheduling data appears on the user's time sensitive scheduling data receiving device display screens.

2. The method of claim 1, further comprising:
accommodating flow management of passive delivery of time sensitive scheduling data to a time sensitive scheduling data receiving device via the time sensitive scheduling data delivery network.

3. The method of claim 1, further comprising:
identifying classes of time sensitive scheduling data to receive on the user's time sensitive scheduling data receiving device;
receiving time sensitive scheduling data items within that class of time sensitive scheduling data when those items become available and until the activity or observance has expired; and
filtering certain time sensitive scheduling data streams dynamically.

4. The method of claim 1, further comprising:
customizing flow of content and receipt of the time sensitive scheduling data to the user by tuning or adjusting a user's profile.

5. The method of claim 4, wherein the user's profile is selected from the group consisting of channel subscriptions, designated and derived affiliations, personal observance items, reminder designations, designated and derived areas of interests, biographic data, psycho-graphic data, geographic data, and a combination thereof.

6. The method of claim 1, further comprising:
restricting the time sensitive scheduling data receiving device to receiving only certain pre-designated time sensitive scheduling data channels assigned to specific time sensitive scheduling data display zones.

7. The method of claim 1, further comprising:
sending and receiving time sensitive scheduling data related to activities of at least one of originating organizations, affiliated groups of individuals, and individuals.

8. The method of claim 1, further comprising:
transmitting specific time sensitive scheduling data stream that is an aggregation of activities for a specific time frame related to sources comprises at least one of the group of an originating organization, an affiliated group of individuals, and an individual.

9. The method of claim 1, further comprising:
transmitting specific time sensitive scheduling data stream that is an aggregation of display classes of time sensitive scheduling data for a specific time frame.

10. The method of claim 1, further comprising:
delivering time sensitive scheduling data via specific time sensitive scheduling data receiving devices that comprises deriving interest for an entity by matching the receiving entity's selections for receiving time sensitive scheduling data based on the receiving entity's definition of what constitutes specific filtered time sensitive scheduling data display zone classes.

11. The method of claim 10, wherein the specific filtered time sensitive scheduling data display zone classes are selected from the group consisting of preference items, interest items, informational items, reservations, reminders, logistics items, notices and alerts, and observances.

12. The method of claim 1, further comprising:
transmitting specific filtered time sensitive scheduling data display zone classes comprising at least one item.

13. The method of claim 1, further comprising:
streaming only filtered time sensitive scheduling data that relates to a specific category of time sensitive scheduling data display zone class.

14. The method of claim 13, wherein the filtered time sensitive scheduling data may be delivered to the entity wherever the entity may be.

15. The method of claim 1, further comprising:
assigning time sensitive scheduling data channels to an interest item display zone class by using an entity's area of interest to define time sensitive schedule data interest items.

16. The method of claim 1, further comprising:
assigning time sensitive scheduling data channels to a preference item display zone class by using an entity's affiliations to define time sensitive schedule data preference items.

17. The method of claim 1, further comprising:
assigning time sensitive scheduling data channels to a reminder display zone class by using a receiving entity's flagged reminders to define time sensitive schedule data reminders.

18. The method of claim 1, further comprising:
assigning time sensitive scheduling data channels to a reservation display zone class by using a receiving entity's reservations to define time sensitive schedule data reservations.

19. The method of claim 1, further comprising:
assigning time sensitive scheduling data channels to a notices and alerts display zone class by using an entity's need to know areas to define time sensitive schedule data notices and alerts.

20. The method of claim 1, further comprising:
assigning time sensitive scheduling data channels to an informational item display zone class by using an entity's affinities to define time sensitive schedule data informational items.

21. The method of claim 1, further comprising:
assigning time sensitive scheduling data channels to a reminder display zone class by using a receiving entity's flagged reminders to define time sensitive schedule data logistics items.

22. The method of claim 1, further comprising:
assigning time sensitive scheduling data channels to a notices and alerts display zone class by using an entity's need to know areas to define time sensitive schedule data observances.

23. The method of claim 1, wherein the time sensitive scheduling data delivery network is a communications network selected from the group consisting of a cellular telephony communications network, a Internet communications network, a broadcast TV/Radio communications network, a satellite communications network, and a combination thereof.

24. A system for controlling the flow of content and receipt of time sensitive scheduling data to an entity, the system comprising:
a time sensitive scheduling data center for storing user and device time sensitive scheduling data display class preferences, collecting user and device time sensitive scheduling data display class preferences, and sending user and device time sensitive scheduling data display class preferences to a receiving entity;
connectivity medium communication interfaces for transmitting user and device time sensitive scheduling data display class preferences between the time sensitive scheduling data center, a communication technology, and a time sensitive scheduling data receiving device;
a communication technology suitable for receiving and sending user and device time sensitive scheduling data display class preferences;
processors that process executable instructions for:
accommodating management of display of potentially voluminous time sensitive scheduling data;
making all of relevant time sensitive scheduling data information available from high capacity remote data stores accessible to all of a user's time sensitive scheduling data receiving devices via a time sensitive scheduling data delivery network, and on demand by a time sensitive scheduling data display zone category to the user's time sensitive scheduling data receiving devices; and
managing dynamically which display zone classes and subclasses of time sensitive scheduling data appear, which time frames appear and how much time sensitive scheduling data appears on the user's time sensitive scheduling data receiving device display screens; and
a time sensitive scheduling data receiving device for receiving and sending user and device time sensitive scheduling data display class preferences to the time sensitive scheduling data center via the connectivity medium communication interfaces via the communication technology.

25. The system of claim 24, further comprising:
at least one of the processors processing an executable instruction for accommodating flow management of passive delivery of time sensitive scheduling data to a time sensitive scheduling data receiving device via the time sensitive scheduling data delivery network.

26. The system of claim 25, further comprising:
at least one of the processor processing an executable instruction for identifying classes of time sensitive scheduling data to receive on the user's time sensitive scheduling data receiving device;
receiving time sensitive scheduling data items within that class of time sensitive scheduling data when those items become available and until the activity or observance has expired; and
filtering certain time sensitive scheduling data streams dynamically.

27. The system of claim 24, further comprising:
at least one of the processors processing an executable instruction for customizing flow of content and receipt of the time sensitive scheduling data to the user by tuning or adjusting a user's profile.

28. The system of claim 27, wherein the user's profile is selected from the group consisting of channel subscriptions, designated and derived affiliations, personal observance items, reminder designations, designated and derived areas of interests, biographic data, psycho-graphic data, geographic data, and a combination thereof.

29. The system of claim 24, further comprising:
at least one of the processors for processing for processing an executable instruction for restricting the time sensitive scheduling data receiving device to receiving only certain pre-designated time sensitive scheduling data channels assigned to specific time sensitive scheduling data display zones.

30. The system of claim 24, further comprising:
at least one of the processors for processing an executable instruction for sending and receiving time sensitive scheduling data related to activities of at least one of originating organizations, affiliated groups of individuals, and individuals.

31. The system of claim 24, further comprising:
at least one of the processors for processing an executable instruction for transmitting specific time sensitive scheduling data stream that is an aggregation of activities for a specific time frame related to sources comprises at least one of the group of an originating organization, an affiliated group of individuals, and an individual.

32. The system of claim 24, further comprising:
at least one of the processors for processing an executable instruction for transmitting specific time sensitive scheduling data stream that is an aggregation of display classes of time sensitive scheduling data for a specific time frame.

33. The system of claim 24, further comprising:
at least one of the processors for processing an executable instruction for delivering time sensitive scheduling data via specific time sensitive scheduling data receiving devices that comprises deriving interest for an entity by matching the receiving entity's selections for receiving time sensitive scheduling data based on the receiving entity's definition of what constitutes specific filtered time sensitive scheduling data display zone classes.

34. The system of claim 33, wherein the specific filtered time sensitive scheduling data display zone classes are selected from the group consisting of preference items, interest items, informational items, reservations, reminders, logistics items, notices and alerts, and observances.

35. The system of claim 24, further comprising:
at least one of the processors for processing an executable instruction for transmitting specific filtered time sensitive scheduling data display zone classes comprising at least one item.

36. The system of claim 24, further comprising:
at least one of the processors processing an executable instruction for streaming only filtered time sensitive scheduling data that relates to a specific category of time sensitive scheduling data display zone class.

37. The system of claim 36, wherein the filtered time sensitive scheduling data may be delivered to the entity wherever the entity may be.

38. The system of claim 24, further comprising:
at least one of the processors processing an executable instruction for assigning time sensitive scheduling data channels to an interest item display zone class by using an entity's area of interest to define time sensitive schedule data interest items.

39. The system of claim 24, further comprising:
at least one of the processors processing an executable instruction for assigning time sensitive scheduling data channels to a preference item display zone class by using an entity's affiliations to define time sensitive schedule data preference items.

40. The system of claim 24, further comprising:
at least one of the processors processing an executable instruction for assigning time sensitive scheduling data channels to a reminder display zone class by using a receiving entity's flagged reminders to define time sensitive schedule data reminders.

41. The system of claim 24, further comprising:
at least one of the processors processing an executable instruction for assigning time sensitive scheduling data channels to a reservation display zone class by using a receiving entity's reservations to define time sensitive schedule data reservations.

42. The system of claim 24, further comprising:
at least one of the processors processing an executable instruction for assigning time sensitive scheduling data channels to a notices and alerts display zone class by using an entity's need to know areas to define time sensitive schedule data notices and alerts.

43. The system of claim 24, further comprising:
at least one of the processors processing an executable instruction for assigning time sensitive scheduling data channels to an informational item display zone class by using an entity's affinities to define time sensitive schedule data informational items.

44. The system of claim 24, further comprising:
at least one of the processors processing an executable instruction for assigning time sensitive scheduling data channels to a reminder display zone class by using a receiving entity's flagged reminders to define time sensitive schedule data logistics items.

45. The system of claim 24, further comprising:
at least one of the processors processing an executable instruction for assigning time sensitive scheduling data channels to a notices and alerts display zone class by using an entity's need to know areas to define time sensitive schedule data observances.

46. The system of claim 24, wherein the time sensitive scheduling data delivery network is a communications network selected from the group consisting of a cellular telephony communications network, a Internet communications network, a broadcast TV/Radio communications network, a satellite communications network, and a combination thereof.

47. A time sensitive scheduling data receiving display device, the device comprising:
a display for displaying specific classes of upcoming, relevant, and targeted time sensitive scheduling data occurring within a predefined time period of the current time reflected on a time sensitive scheduling data receiving display device.

48. The time sensitive scheduling data receiving display device according to claim 47, wherein the time sensitive scheduling data receiving display device can display information related to designated areas of interest, specific sources of time sensitive scheduling data to inform viewers of upcoming activities, approaching deadlines, transit status of people and goods, and requested reminders related to upcoming activities and observances.

49. The time sensitive scheduling data receiving display according to claim 48, wherein the time sensitive scheduling data receiving display device is a digital clock

50. The time sensitive scheduling data receiving display according to claim 48, wherein the time sensitive scheduling data receiving display device is a digital picture frame.

51. The time sensitive scheduling data receiving display according to claim 48, wherein the time sensitive scheduling data receiving display device is a wireless router.

52. The time sensitive scheduling data receiving display according to claim 48, wherein the time sensitive scheduling data receiving display device is a set top receiver.

53. A computer program product executable by a computer processor for processing a controlling flow of content and receipt of time sensitive scheduling data via a time sensitive scheduling data network, comprising:
computer code, which when executed causes a processor to accommodate management of display of potentially voluminous time sensitive scheduling data;
computer code, which when executed causes a processor to make all of relevant time sensitive scheduling data information available from high capacity remote data stores accessible to all of a user's time sensitive scheduling data receiving devices via a time sensitive scheduling data network, and available on demand by a time sensitive scheduling data display zone category to the user's time sensitive scheduling data receiving devices;
computer code, which when executed causes a processor to manage dynamically which display zone classes and subclasses of time sensitive scheduling data appear, which time frames appear and how much time sensitive scheduling data appears on the user's time sensitive scheduling data receiving device display screens; and
computer readable-medium storing the computer code.

54. The computer program product of claim 53, further comprising:
accommodating flow management of passive delivery of time sensitive scheduling data to a time sensitive scheduling data receiving device via the time sensitive scheduling data delivery network.

55. The computer program product of claim 53, further comprising:
identifying classes of time sensitive scheduling data to receive on the user's time sensitive scheduling data receiving device;
receiving time sensitive scheduling data items within that class of time sensitive scheduling data when those items become available and until the activity or observance has expired; and
filtering certain time sensitive scheduling data streams dynamically.

56. The computer program product of claim 53, further comprising:
customizing flow of content and receipt of the time sensitive scheduling data to the user by tuning or adjusting a user's profile.

57. The computer program product of claim 56, wherein the user's profile is selected from the group consisting of channel subscriptions, designated and derived affiliations, personal observance items, reminder designations, designated and derived areas of interests, biographic data, psycho-graphic data, geographic data, and a combination thereof.

58. The computer program product of claim 53, further comprising:
restricting the time sensitive scheduling data receiving device to receiving only certain pre-designated time sensitive scheduling data channels assigned to specific time sensitive scheduling data display zones.

59. The computer program product of claim 53, further comprising:
sending and receiving time sensitive scheduling data related to activities of at least one of originating organizations, affiliated groups of individuals, and individuals.

60. The computer program product of claim 53, further comprising:
transmitting specific time sensitive scheduling data stream that is an aggregation of activities for a specific time frame related to sources comprises at least one of the group of an originating organization, an affiliated group of individuals, and an individual.

61. The computer program product of claim 53, further comprising:
transmitting specific time sensitive scheduling data stream that is an aggregation of display classes of time sensitive scheduling data for a specific time frame.

62. The computer program product of claim 53, further comprising:
delivering time sensitive scheduling data via specific time sensitive scheduling data receiving devices that comprises deriving interest for an entity by matching the receiving entity's selections for receiving time sensitive scheduling data based on the receiving entity's definition of what constitutes specific filtered time sensitive scheduling data display zone classes.

63. The computer program product of claim 62, wherein the specific filtered time sensitive scheduling data display zone classes are selected from the group consisting of preference items, interest items, informational items, reservations, reminders, logistics items, notices and alerts, and observances.

64. The computer program product of claim 53, further comprising:
transmitting specific filtered time sensitive scheduling data display zone classes comprising at least one item.

65. The computer program product of claim 53, further comprising:
streaming only filtered time sensitive scheduling data that relates to a specific category of time sensitive scheduling data display zone class.

66. The computer program product of claim 65, wherein the filtered time sensitive scheduling data may be delivered to the entity wherever the entity may be.

67. The computer program product of claim 53, further comprising:
assigning time sensitive scheduling data channels to an interest item display zone class by using an entity's area of interest to define time sensitive schedule data interest items.

68. The computer program product of claim 53, further comprising:
assigning time sensitive scheduling data channels to a preference item display zone class by using an entity's affiliations to define time sensitive schedule data preference items.

69. The computer program product of claim 53, further comprising:
assigning time sensitive scheduling data channels to a reminder display zone class by using a receiving entity's flagged reminders to define time sensitive schedule data reminders.

70. The computer program product of claim 53, further comprising:
assigning time sensitive scheduling data channels to a reservation display zone class by using a receiving entity's reservations to define time sensitive schedule data reservations.

71. The computer program product of claim 53, further comprising:
assigning time sensitive scheduling data channels to a notices and alerts display zone class by using an entity's need to know areas to define time sensitive schedule data notices and alerts.

72. The computer program product of claim 53, further comprising:
assigning time sensitive scheduling data channels to an informational item display zone class by using an entity's affinities to define time sensitive schedule data informational items.

73. The computer program product of claim 53, further comprising:
assigning time sensitive scheduling data channels to a reminder display zone class by using a receiving entity's flagged reminders to define time sensitive schedule data logistics items.

74. The computer program product of claim 53, further comprising:
assigning time sensitive scheduling data channels to a notices and alerts display zone class by using an entity's need to know areas to define time sensitive schedule data observances.

75. The computer program product of claim 53, wherein the time sensitive scheduling data delivery network is a communications network selected from the group consisting of a cellular telephony communications network, a Internet communications network, a broadcast TV/Radio communications network, a satellite communications network, and a combination thereof.

76. A computer program product executable by a computer processor for processing a grid flow management system, comprising:
computer code, which when executed causes a processor to
create a user's session profile, updating a user's session profile,
create specific time sensitive scheduling data based on a receiving entity's time sensitive scheduling data channels, user and device time sensitive scheduling data class preferences, current time, and requested time frame,
transmit time sensitive scheduling data fulfillment requests to time sensitive scheduling data server, receiving time sensitive scheduling data from the fulfillment requests,
transmit time sensitive scheduling data matching parameters to a promotions server,
receive promotional content,
format all requested time sensitive scheduling data and promotional content, and
transmit time sensitive scheduling data streams to a time sensitive scheduling data receiving device;
computer code, which when executed causes a processor to
update the time sensitive scheduling data class preferences in authorization record for the receiving entity,
transmit subscriber profile identifier, the receiving entity's time sensitive scheduling data display class preferences, and administrative parameters such as session profile identifier, starting time, and network use limitations, and
request the receiving entity's subscriber profile from a subscriber profile server;
computer code, which when executed causes a processor to return the receiving entity's subscriber profile identifier to the authentication server;
computer code for managing the receipt, maintenance, and storage of time sensitive scheduling data;
computer code for managing the receipt, maintenance, and storage of promotion content; and
computer readable-medium for storing the computer code.

77. A grid flow management system, comprising:
a fulfillment server, by executing on a host system, creating a user's session profile, updating a user's session profile, creating specific time sensitive scheduling data based on a—receiving entity's time sensitive scheduling data channels, user and device time sensitive scheduling data class preferences, current time, and requested time frame, transmitting time sensitive scheduling data fulfillment requests to time sensitive scheduling data server, receiving time sensitive scheduling data from the fulfillment requests, transmitting time sensitive scheduling data matching parameters to a promotions server, receiving promotional content, formatting all requested time sensitive scheduling data and promotional content, and transmitting time sensitive scheduling data streams to a time sensitive scheduling data receiving device;
an authentication server, by executing on the host system,
updating the time sensitive scheduling data class preferences in authorization record for the receiving entity,
transmitting subscriber profile identifier, the receiving entity's time sensitive scheduling data display class preferences, and administrative parameters such as session profile identifier, starting time, and network use limitations, and
requesting the receiving entity's subscriber profile from a subscriber profile server;
the subscriber profile server, by executing on a host system, returning the receiving entity's subscriber profile identifier to the authentication server;
the time sensitive scheduling data server, by executing on a host system, managing the receipt, maintenance, and storage of time sensitive scheduling data;
a promotions server managing the receipt, maintenance, and storage of promotion content;
a data store; and
time sensitive scheduling data receiving devices.
